(19) United States
(12) Patent Application Publication
(10) Pub. No.: US 2016/0132596 A1
(43) Pub. Date: May 12, 2016

(54) Generating Search Results Based On Software Application Installation Status

(71) Applicant: Quixey, Inc., Mountain View, CA (US)

(72) Inventors: Michael Harris, Mountain View, CA (US); Shravan Sogani, San Ramon, CA (US)

(73) Assignee: Quixey, Inc., Mountain View, CA (US)

(21) Appl. No.: 14/620,825

(22) Filed: Feb. 12, 2015

Related U.S. Application Data
(60) Provisional application No. 62/078,681, filed on Nov. 12, 2014.

(51) Int. Cl. G06F 17/30; G06F 3/0482; G06F 21/62; G06F 9/445

(52) U.S. Cl. CPC G06F 17/30864; G06F 8/65; G06F 17/30554; G06F 3/0482; G06F 21/6245

(57) ABSTRACT

Techniques include receiving a search query from a user device, determining native applications installed on the user device, and identifying function records based on the search query and the applications. In this example, each function record includes an application access mechanism (AAM) and application state information (ASI). The AAM references a native application and indicates operations for it to perform. The ASI describes a state of the application after it has performed the operations. In this example, identifying the function records based on the applications includes determining that the AAM included in each function record references one of the applications. The method further includes selecting AAMs from the identified function records, and transmitting the AAMs to the user device. Other techniques include receiving AAMs at a user device, determining native applications installed on the user device, and displaying only those of the received AAMs that reference any of the applications.

### CROSS-REFERENCE TO RELATED APPLICATION

This application claims priority under 35 U.S.C. §119(e) to U.S. Provisional Application 62/078,681, filed Nov. 12, 2014, which is hereby incorporated by reference in its entirety.

### TECHNICAL FIELD

This disclosure generally relates to the field of search, and more particularly to techniques for generating search results that correspond to states within software applications.

### BACKGROUND

In recent years, the use of computers, smartphones, and other Internet-connected computing devices has grown significantly. Correspondingly, the number of software applications available for such computing devices has also grown. Today, many diverse software applications can be accessed on a number of different computing devices, including, but not limited to, smartphones, personal computers, automobiles, and televisions. These software applications can include business driven applications, games, educational applications, news applications, shopping applications, messaging applications, media streaming applications, and social networking applications, as some examples. Because of the large number of software applications available today and the wide range of functionality they provide, computing device users often require the ability to search for and access specific software application functionality.

### SUMMARY

In one example, a method includes receiving a search query from a user device, determining one or more native applications that are installed on the user device, and identifying function records based on the search query and based on the one or more native applications. In this example, each function record includes an application access mechanism (AAM) and application state information (ASI). The AAM references a native application and indicates one or more operations for the native application to perform. The ASI describes a state of the native application after the native application has performed the one or more operations. Also in this example, identifying the function records based on the one or more native applications includes determining that the AAM included in each function record references one of the one or more native applications. The method further includes selecting one or more AAMs from the identified function records, and transmitting the selected one or more AAMs to the user device.

In another example, a method includes transmitting, using a user device, a search query to a search system configured to generate search results in response to a received search query, and receiving search results from the search system at the user device in response to the search query. In this example, the search results include one or more AAMs that each reference a native application and indicate one or more operations for the native application to perform. The method further includes determining, using the user device, one or more native applications that are installed on the user device. The method includes, for each of the one or more AAMs that references any of the one or more native applications, generating, using the user device, a user selectable link that includes the AAM and displaying the user selectable link on the user device. The method also includes, for each of the one or more AAMs that does not reference any of the one or more native applications, refraining from generating a user selectable link that includes the AAM and displaying the user selectable link on the user device.

In another example, a system includes one or more computing devices configured to receive a search query from a user device, determine one or more native applications that are installed on the user device, and identify function records based on the search query and based on the one or more native applications. In this example, each function record includes an AAM and ASI. The AAM references a native application and indicates one or more operations for the native application to perform. The ASI describes a state of the native application after the native application has performed the one or more operations. Also in this example, to identify the function records based on the one or more native applications, the one or more computing devices are configured to determine that the AAM included in each function record references one of the one or more native applications. The one or more computing devices are further configured to select one or more AAMs from the identified function records, and transmit the selected one or more AAM to the user device.

In another example, a system includes one or more computing devices configured to transmit a search query to a search system configured to generate search results in response to a received search query, and receive search results from the search system in response to the search query. In this example, the search results include one or more AAMs that each reference a native application and indicate one or more operations for the native application to perform. The one or more computing devices are further configured to determine one or more native applications that are installed on a user device. The one or more computing devices are configured to, for each of the one or more AAMs that references any of the one or more native applications, generate a user selectable link that includes the AAM and display the user selectable link. The one or more computing devices are also configured to, for each of the one or more AAMs that does not reference any of the one or more native applications, refrain from generating a user selectable link that includes the AAM and displaying the user selectable link.

In another example, a non-transitory computer-readable storage medium includes instructions that cause one or more computing devices to receive a search query from a user device, determine one or more native applications that are installed on the user device, and identify function records based on the search query and based on the one or more native applications. In this example, each function record includes an AAM and ASI. The AAM references a native application and indicates one or more operations for the native application to perform. The ASI describes a state of the native application after the native application has performed the one or more operations. Also in this example, the instructions that cause the one or more computing devices to identify the function records based on the one or more native applications include instructions that cause the one or more computing devices to determine that the AAM included in each function record references one of the one or more native applications. The instructions further cause the one or more computing devices to select one or more AAMs from the identified function records, and transmit the selected one or more AAMs to the user device.

In another example, a non-transitory computer-readable storage medium includes instructions that cause one or more computing devices to transmit, using a user device, a search query to a search system configured to generate search results in response to a received search query, and receive search results from the search system at the user device in response to the search query. In this example, the search results include one or more AAMs that each reference a native application and indicate one or more operations for the native application to perform. The instructions further cause the one or more computing devices to determine, using the user device, one or more native applications that are installed on the user device. The instructions cause the one or more computing devices to, for each of the one or more AAMs that references any of the one or more native applications, generate, using the user device, a user selectable link that includes the AAM and display the user selectable link on the user device. The instructions also cause the one or more computing devices to, for each of the one or more AAMs that does not reference any of the one or more native applications, refrain from generating a user selectable link that includes the AAM and displaying the user selectable link on the user device.

The details of one or more implementations of the disclosure are set forth in the accompanying drawings and the description below. Other aspects, features, and advantages will be apparent from the description and drawings, and from the claims.

### BRIEF DESCRIPTION OF DRAWINGS

FIG. 1 shows an example environment that includes a search system, one or more user devices, and one or more data sources in communication via a network.

FIG. 2 shows an example user device in communication with a search system.

FIG. 3 is a functional block diagram of an example search module.

FIGS. 4A-4B show example function records included in a search data store.

FIG. 5A is a flow diagram that illustrates an example method for displaying search results on a user device based on software applications installed on the user device.

FIG. 5B is a flow diagram that illustrates an example method for generating search results based on a received search query and transmitting the search results to a user device.

FIG. 6 shows another example user device in communication with a search system.

FIG. 7 is a functional block diagram of another example search module.

FIGS. 8A-8B show other example function records included in a search data store.

FIG. 9A is a flow diagram that illustrates an example method for displaying search results received from a search system in response to a search query on a user device.

FIG. 9B is a flow diagram that illustrates an example method for generating search results based on a received search query and applications installed on a user device.

FIGS. 10A-10B illustrate example graphical user interfaces (GUIs) that may be generated on a user device according to the present disclosure.

Like reference symbols in the various drawings indicate like elements.

### DETAILED DESCRIPTION

The present disclosure generally relates to the field of search, and, more particularly, to techniques for generating and displaying search results on a computing device based on software applications that are installed on the computing device. According to the techniques of this disclosure, a user device may transmit a search query to a search system and receive search results that are responsive to the search query. The user device may display the search results to a user of the user device. The displayed search results may include one or more user selectable links that, when selected by the user on the user device, direct the user device to one or more application states within one or more native applications (e.g., applications that are used by first installing the applications on a computing device). The user selectable links may indicate (e.g., using text and/or image data) to the user the corresponding application states within the native applications. According to the techniques disclosed herein, the displayed search results may include one or more user selectable links that each specify an application state within a native application that is installed on the user device, and may not include any user selectable links that specify application states within native applications that are not installed on the user device.

An application state of a native application may refer to one or more graphical user interfaces (GUIs), or so-called “screens,” within the application. In general, an application state of this disclosure may refer to a configuration of a native application in which the application displays content to the user, such as information related to one or more products, services, or vendors provided by, or accessible via, the application. An application state, as used herein, may also refer to a function provided by a native application. As one example, an application state of a native online shopping application may correspond to a screen of the application that describes (e.g., using text and/or image data) a particular product or service sold through the application (e.g., by one or more vendors associated with the application). As another example, an application state of a native music player application may correspond to a screen of the application that describes (e.g., using text and/or image data) a particular song that the application may play to a user (e.g., a name of the song, an album, and/or a musical artist).

The present disclosure describes various implementations for displaying search results that specify application states within native applications that are installed on a user device, and refraining from displaying search results that specify application states within native applications that are not installed on the user device. In some implementations, the search system may receive the search query from the user device and generate the search results based on the received search query. For example, using the search query, the search system may identify one or more application access mechanisms (hereinafter, “AAMs”) that each specify an application state of a native application. An AAM, as used herein, may refer to a string that references a native application and indicates one or more operations for a user device to perform. In response to selection of an AAM (e.g., a user selectable link that includes the AAM) by a user on a user device, the user device may launch a native application referenced by the AAM and perform one or more operations indicated by the AAM. In these implementations, the search system may identify one or more function records that include the AAMs based on the search query, and select the AAMs from the identified function records. The search system may then transmit the AAMs to the user device. The user device may receive the AAMs from the search system. The user device may further determine one or more native applications that are installed on the user device. A native application that is installed on a user device may also be referred to herein as a native application that is available on the user device. The user device may generate one or more user selectable links for those of the AAMs received from the search system that reference any of the installed, or available, native applications, and display the user selectable links on the user device. Specifically, the user device may determine whether any of the AAMs reference any of the installed native applications. For each AAM that references an installed native application, the user device may generate a user selectable link that includes the AAM and display the user selectable link on the user device. For each AAM that does not reference an installed native application, the user device may refrain from generating or displaying a user selectable link that includes the AAM.

In some examples, to determine the installed native applications, the user device may poll an operating system (OS) of the user device, receive indications of the installed native applications from the OS in response to polling the OS, and determine the installed native applications based on the received indications. In other examples, the user device may retrieve the indications from a data store (e.g., located within the user device, the search system, or another device or system). In these examples, prior to retrieving the indications from the data store, the user device may poll the OS of the user device, receive the indications from the OS in response to polling the OS, and store the indications in the data store. Also in these examples, prior to retrieving the indications from the data store, the user device may poll the OS, receive update information for some or all of the indications stored in the data store in response to polling the OS, and update the corresponding indications using the received update information.

In some examples, each of the AAMs received from the search system may include an application identifier (AppID) that identifies the native application referenced by the AAM. In these examples, to determine whether any of the AAMs reference any of the installed native applications, the user device may compare the AppID for each of the AAMs to each of one or more of the installed native applications. The user device may then determine whether any of the AAMs reference any of the installed native applications based on the comparison. In other examples, to determine the installed native applications, the user device may determine one or more AppIDs that each identify one of the installed native applications. In these examples, to compare the AppID for each of the AAMs to each of the one or more of the installed native applications as described above, the user device may compare the AppID for each of the AAMs to each of one or more of the AppIDs that identify the installed native applications.

In some examples, each of the AAMs received from the search system may include an application resource identifier (ARI). In these examples, to determine whether any of the AAMs reference any of the installed native applications as described above, the user device may compare at least a portion of the ARI included in each of the AAMs (e.g., a domain name portion that indicates a native application referenced by the AAM) to each of one or more of the installed native applications. The user device may then determine whether any of the AAMs reference any of the installed native applications based on the comparison. In these examples, the portion of the ARI included in each of the AAMs may include a domain name that indicates (e.g., by a native application name) the native application referenced by the AAM.

In other implementations, the search system may receive the search query from the user device, determine the native applications that are installed on the user device, and generate the search results based on the received search query and based on the installed native applications. For example, using the search query and the installed native applications, the search system may identify one or more AAMs that each specify an application state of one of the installed native applications. In these examples, the search system may identify one or more function records that include the AAMs based on the search query and based on the installed native applications. For example, to identify the function records based on the installed native applications, the search system may determine that the AAM included in each function record references one of the installed native applications. The search system may then select the AAMs from the identified function records and transmit the AAMs to the user device. In these implementations, the user device may receive the AAMs from the search system, generate one or more user selectable links for the AAMs, and display the user selectable links on the user device, in a similar manner as described above.

In some examples, to identify the function records based on the search query and based on the one or more native applications, the search system may identify a plurality of function records that includes the identified function records based on the search query. The search system may further select the identified function records from the plurality of function records based on the installed native applications (e.g., select function records that include AAMs that reference the installed native applications). In other examples, to identify the function records based on the search query and based on the installed native applications, the search system may perform a search of a data store that includes the plurality of function records including the identified function records using the search query and the installed native applications as search parameters. In these examples, the search query may be configured to restrict a search space of the search (e.g., identify a subset of the plurality of function records), while the installed native applications may be configured to further restrict the search space of the search (e.g., reduce the identified subset of the plurality of function records). Alternatively, the installed native applications may be configured to restrict the search space of the search (e.g., identify the subset), and the search query may be configured to further restrict the search space of the search (e.g., reduce the subset). For example, the search system may identify a plurality of function records, including the identified function records, that each include an AAM that references one of the installed native applications, and select the identified function records from the plurality of function records based on the search query.

In some examples, to determine the installed native applications, the search system may receive indications of the installed native applications from the user device, and determine the installed native applications based on the received indications. For example, the search system may receive the indications from the user device along with the search query as part of a query wrapper. In some examples, to receive the indications, the search system may transmit a request for the indications to the user device, and receive the indications from the user device in response to the transmitted request. In other examples, the search system may retrieve the indications from a data store. In these examples, prior to retrieving the indications from the data store, the search system may receive the indications from the user device (e.g., in response to transmitting a request for the indications to the user device), and store the indications in the data store. In still other examples, prior to retrieving the indications from the data store, the search system may receive update information for some or all of the indications stored in the data store from the user device (e.g., in response to transmitting a request for the update information to the user device), and update the corresponding indications using the received update information.

In some examples, to determine the installed native applications as described above, the search system may determine one or more AppIDs that each identify one of the installed native applications. In these examples, to determine that the AAM included in each of the identified function records references one of the installed native applications as also described above, the search system may determine that the identified function record includes one of the AppIDs. In these examples, each of the identified function records may include an AppID that identifies the native application referenced by the AAM included in the function record.

In some examples, a user of the user device may specify which of the installed native applications may be used to generate and display the search results in the manner described above. For example, the user may identify (e.g., via an AppID) one or more of the installed native applications that the user deems private and that should therefore be excluded from being considered by the search system or the user device as part of generating and displaying the search results. In some examples, the user may specify a subset (e.g., one or more) of the installed native applications that excludes any such private native applications. Alternatively, the user may assign a privacy value to each of one or more of the installed native applications. Each privacy value may indicate a relative degree of privacy (e.g., as indicated by a position of the privacy value within a specified range of privacy values) that the user wishes to associate with the corresponding installed native application. In some examples, the user device, the search system, or another device or system, may define the subset of the installed native applications described above based on the one or more privacy values associated with the installed native applications. For example, the subset may exclude any of the installed native applications that have a privacy value that is above (or below) a threshold privacy value also specified by the user or defined using other means. In any case, in some implementations, the user device may generate and display one or more user selectable links for those of the AAMs received from the search system that reference any of the software applications included in the subset. The user device may refrain from generating and displaying any user selectable links for those of the AAMs received from the search system that reference software applications not included in the subset, irrespective of whether the applications are installed on the user device. Alternatively, in other implementations, the search system may identify one or more AAMs that each specify an application state of one of the software applications included in the subset. In these examples, the search system may identify one or more function records that include the AAMs based on the search query and based on the software applications included in the subset. For example, to identify the function records based on the software applications included in the subset, the search system may determine that the AAM included in each function record references one of the software applications included in the subset. The search system may then select the AAMs from the identified function records and transmit the AAMs to the user device. The user device may receive the AAMs from the search system, generate one or more user selectable links for the AAMs, and display the user selectable links on the user device, in the manner described above.

In this manner, the techniques of the present disclosure may, in some examples, enable generating and displaying search results on a user device that reference one or more software applications that are already installed, or available, on the user device. The techniques may further enable the user device to refrain from generating and displaying search results that do not reference software applications that are installed on the user device (i.e., refrain from generating and displaying search results that reference software applications that are not installed, or are unavailable, on the user device). Using the techniques disclosed herein, the user device may display search results that are both responsive to a user's search query and directly relevant, or applicable, to software applications that are available on the user device. For example, because the displayed search results reference only native applications that are installed on the user device, the user device may access any of the displayed search results without first installing a native application that is unavailable on the user device. Additionally, also using the disclosed techniques, the user of the user device may further specify which of the software applications that are available on the user device should be considered for purposes of generating and displaying the search results in the manner described above. For instance, the user may exclude one or more of the software applications that the user deems private from being considered by the search system or the user device as part of generating and displaying the search results. As a result, because the displayed search results reference only native applications that are installed on the user device and do not reference any software applications that the user deems private, the displayed search results may be relevant to software applications that are both available on the user device and not deemed private by the user.

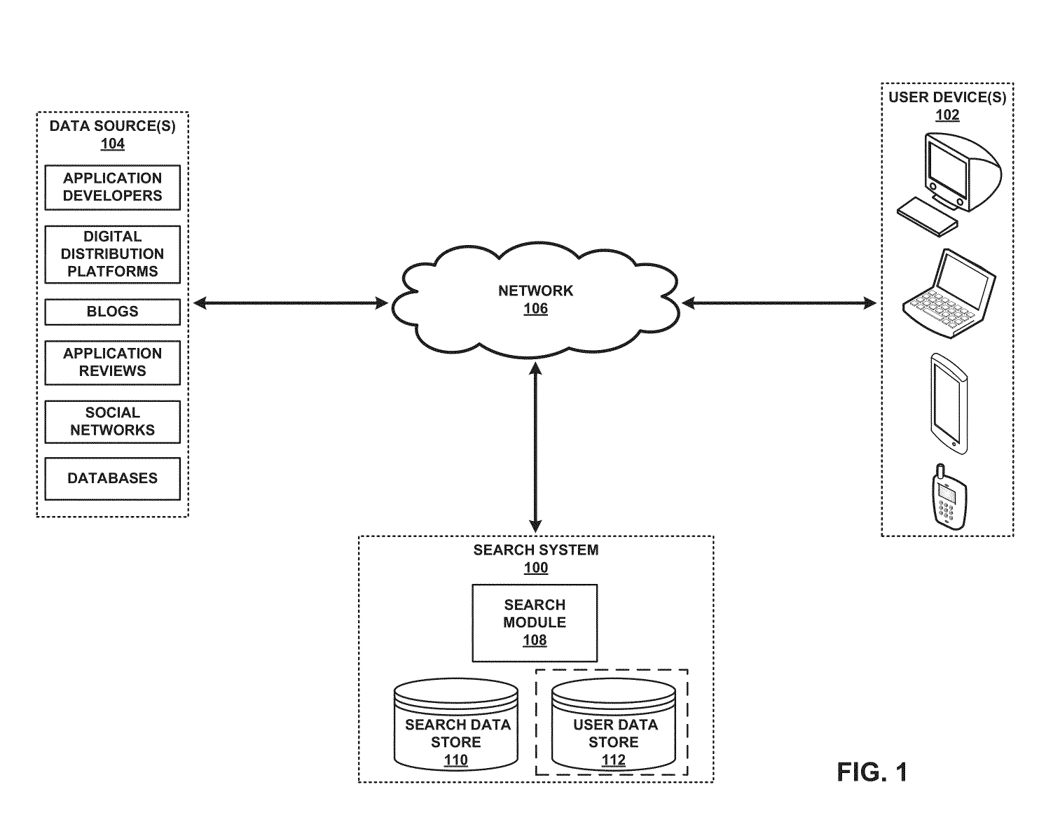

FIG. 1 is a functional block diagram that illustrates an example environment that includes a search system 100 that communicates with one or more user devices 102 and one or more data sources 104 via a network 106. The search system, the user device(s) 102, the data source(s) 104, and the network 106 are described in turn herein.

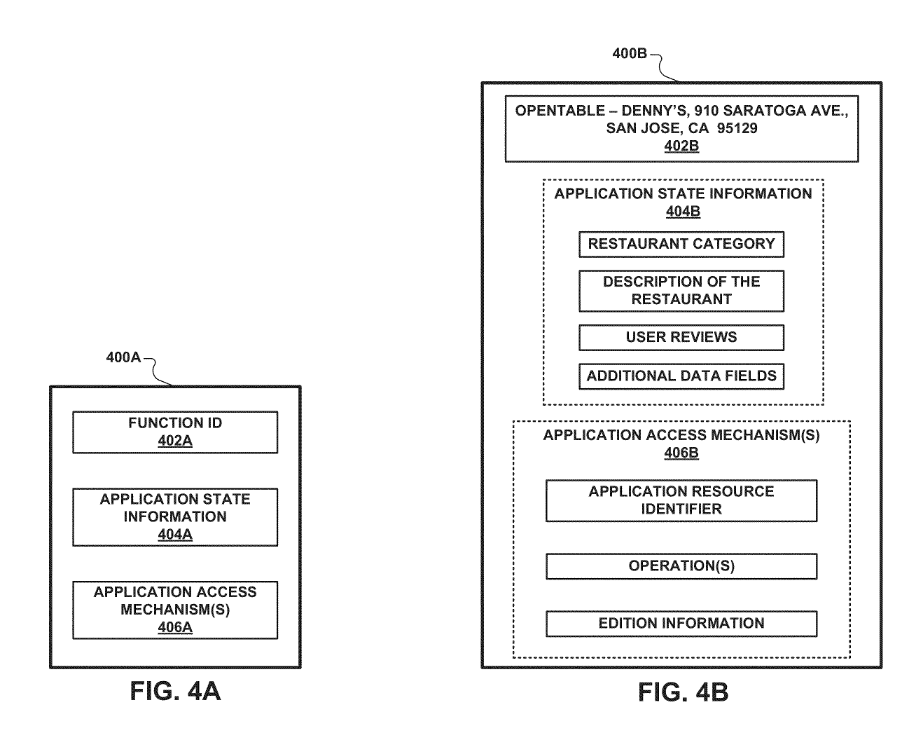

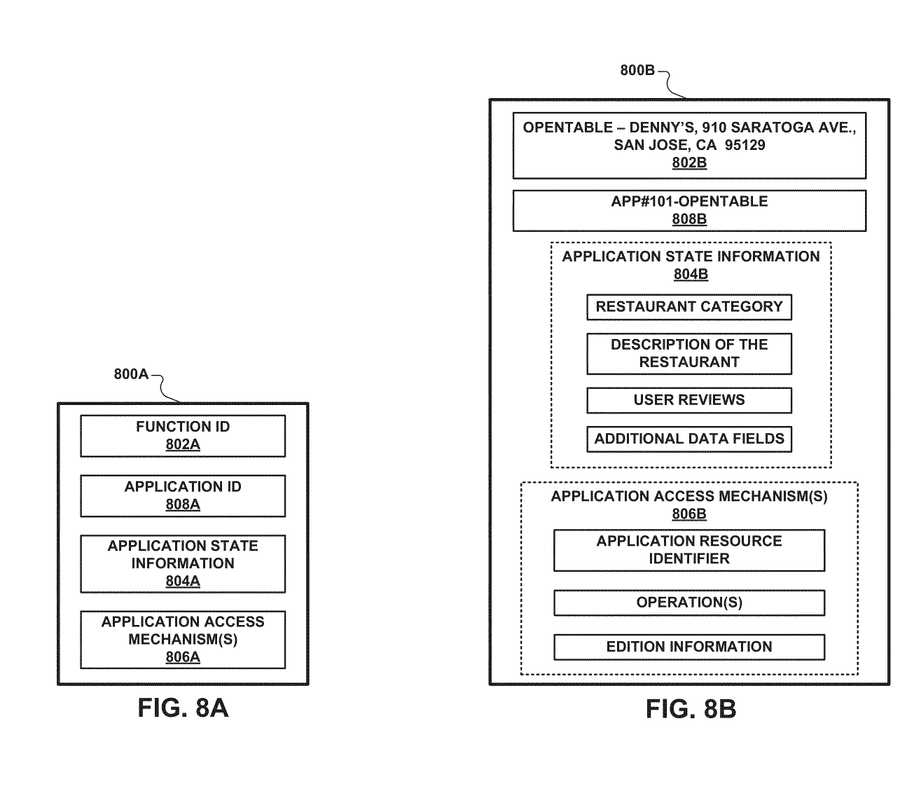

As shown in FIG. 1, the search system 100 includes a search module 108, a search data store 110, and, optionally, a user data store 112. The search module 108 receives search queries from the user device(s) 102, generates search results that are responsive to the search queries, and transmits the search results to the user device(s) 102 that generated the search queries, as described herein. Specifically, the search module 108 generates the search results based on the search queries and data included in the search data store 110. The search data store 110 includes one or more function records, as also described herein. Each function record may include data related to a function of a native application and/or an application state of the application resulting from performance of the function. For example, each function record may include a function identifier (ID), application state information (ASI), one or more AAMs, and, optionally, an application identifier (AppID). Example function records and the various contents thereof are described with reference to FIGS. 4A-4B and 8A-8B. In the example of FIG. 1, to generate the search results based on the search queries and the data included in the search data store 110, the search module 108 is configured to identify function records included in the search data store 110 based on the search queries, select AAMs from the identified function records, and transmit the selected AAMs to the user device(s) 102 that generated the search queries. The search data store 110 may include one or more databases, indices (e.g., inverted indices), tables, files, or other data structures used to implement the techniques of the present disclosure. The optional user data store 112 may include one or more indications of native applications that are installed on a user device 102 (e.g., one of the user device(s) 102), as also described herein. The optional user data store 112 may also include one or more databases, indices (e.g., inverted indices), tables, files, or other data structures, which may be used to implement the techniques of this disclosure.

In general, a search query transmitted by one of the user device(s) 102 to the search system 100 may be a request for information retrieval (e.g., search results) from the search system 100. For example, the search query may be directed to retrieving one or more links to native software application functionality or native software application states in examples where the search system 100 is configured to generate one or more AAMs as search results. A search query directed to retrieving links to native software applications may indicate a user's desire to access functionality of one or more native software applications described by the search query.

A software application, as used herein, may refer to computer software that causes a computing device to perform a task. In some examples, a software application may be referred to as an “application,” an “app,” or a “program.” Example applications include, but are not limited to, word processing applications, spreadsheet applications, messaging applications, media streaming applications, social networking applications, and games.

Applications can be executed on a variety of different computing devices. For example, applications can be executed on mobile computing devices such as smart phones, tablets, and wearable computing devices (e.g., headsets and/or watches). Applications can also be executed on other types of computing devices having other form factors, such as laptop computers, desktop computers, or other consumer electronic devices. In some examples, applications may be installed on a computing device prior to a user purchasing the computing device. In other examples, the user may download and install applications on the computing device after purchasing the computing device.

The functionality of an application may be accessed on the computing device on which the application is installed. Additionally, or alternatively, the functionality of an application may be accessed via a remote computing device. In some examples, all of an application's functionality is included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to a user through the installed weather application. In still other examples, an application (e.g., a web-based application) may be partially executed by a user's computing device and partially executed by a remote computing device. For example, a web application may be an application that is executed, at least in part, by a web server and accessed by a web browser of a user's computing device. Example web applications may include web-based email, online auctions, and online retail sites.

Native applications, as described herein, refer to applications that are accessed, or used, by first installing the applications on a user device 102. The native applications can perform a variety of different functions for a user of the user device 102. For example, a restaurant reservation application can make reservations for restaurants. As another example, an internet media player application can stream media (e.g., a song, or movie) from the Internet. In some examples, a single native application can perform more than one function. For example, a restaurant reservation application may allow a user to retrieve information about a restaurant and read user reviews for the restaurant in addition to making reservations for restaurants. As another example, an internet media player application may allow a user to perform searches for digital media, purchase digital media, and generate digital media playlists in addition to streaming media from the Internet.

An AAM, as also described herein, includes data that a user device 102 can use to access functionality provided by a native application. For example, an AAM may include data that causes a user device 102 to launch a native application and perform a function associated with the native application. Performance of a function according to the AAM may set the native application into a specified application state. Accordingly, the process of launching a native application and performing a function according to an AAM may be referred to herein as launching the native application and setting the application into an application state that is specified by the AAM. In one example, an AAM for a restaurant reservation application can include data that causes a user device 102 to launch the application and make a reservation at a restaurant. In this example, the restaurant reservation application may be set into an application state that displays reservation information to a user, such as a reservation time, a description of the restaurant, and user reviews. In another example, an AAM for an internet media player application can include data that causes a user device 102 to launch the application and stream media from the Internet. In this example, the internet media player application may be set into an application state that displays information regarding the media (e.g., music) being streamed, such as a song name, an artist name, or an album name.

AAMs may have various different formats and content. The format and content of an AAM may depend on the native application with which the AAM is associated and the operations that are to be performed by the application in response to selection of the AAM. For example, an AAM for an internet music player application may differ from an AAM for a shopping application. The AAM for the internet music player application may include references to musical artists, songs, and albums, for example. The AAM for the internet music player application may also reference operations, such as randomizing a list of songs and playing a song or album. The AAM for the shopping application may include references to different products that are for sale. The AAM for the shopping application may also include references to one or more operations, such as adding products to a shopping cart and proceeding to a checkout.

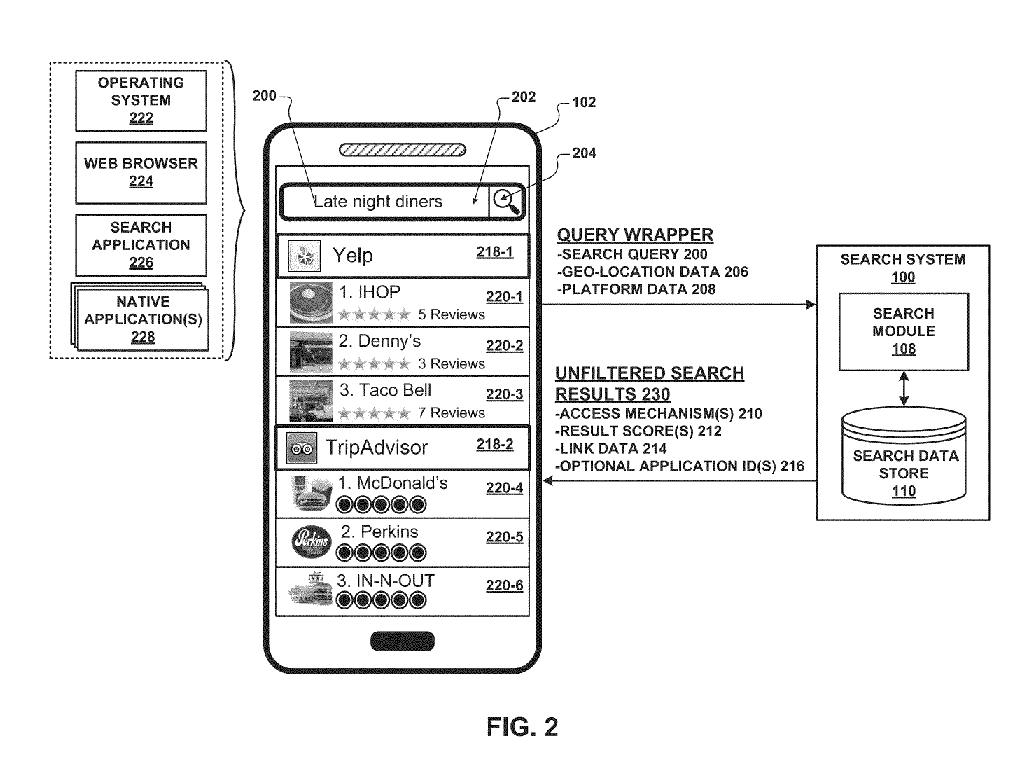

In some examples, the search system 100 may transmit additional data to the user device(s) 102 as part of the search results, i.e., along with the AAMs selected from the identified function records. For example, the search system 100 may transmit link data (e.g., text and/or images) that may be used by the user device(s) 102 to generate user selectable links, or “links,” for the search results. A link may include text and/or images that a user of a user device 102 may select (e.g., click on, or touch) via a user interface of the user device 102. Each link may be associated with an AAM received as part of the search results, such that when the user selects the link, the user device 102 launches a native application referenced by the AAM and performs one or more operations indicated by the AAM. The text and/or images of a link displayed to the user may indicate the operations that will be performed in response to selection of the link. For example, if the link is to a song in a music playing application, the text and/or images may identify the music playing application that will be launched by the user device 102 and the song that will be played by the music playing application when the user selects the link. Example links are illustrated in FIGS. 2, 6, and 10A.

The user may select a particular link to cause the user device 102 to launch a native application identified in the link and perform one or more operations according to an AAM associated with the link. Put another way, when the user selects the link, the user device 102 launches the native application and sets the application into an application state defined by the AAM. In general, an application state of a native application may refer to the operations and/or a resulting outcome of the application performing the operations in response to the user selecting the link. An application state of a native application may also be referred to herein as an “application state.”

An application state of a native application specified by an AAM may depend on the functionality provided by the application. For example, if the native application is configured to retrieve and display information from the Internet, the application can be set into an application state in which the application retrieves information from the Internet and displays information to a user. In another example, if the native application is configured to play media from the Internet (e.g., music and/or video), the application can be set into an application state in which the application plays a song or a movie from the Internet. In still another example, if the native application is configured to make restaurant reservations, the application can be set into an application state in which the application displays available restaurant reservations to a user.

As described herein, the search system 100 generates search results that include one or more AAMs selected from one or more function records identified in the search data store 110. As also described herein, the search system 100 may identify the function records in the search data store 110 based on a search query received from one of the user device(s) 102, and, in some implementations, based on one or more native applications that are installed on the user device 102, which may be referred to herein as “installed native applications.” Initially, the search system 100 analyzes the search query received from the user device 102. The search system 100 then identifies a set of (e.g., one or more) function records included in the search data store 110 based on the received (e.g., analyzed) search query. For example, the search system 100 may identify the function records based on one or more matches (e.g., text matches) between one or more terms of the search query and one or more terms of ASI included in the function records. As described herein, in some implementations, the search system 100 may identify the set of function records also based on the installed native applications. In some examples, the search system 100 may identify a plurality of function records included in the search data store 110 based on the search query, and select the set of function records from the plurality of function records based on the installed native applications. For example, the search system 100 may select function records that include AAMs that reference the installed native applications. In other examples, the search system 100 may perform a search of the search data store 110 using the search query and the installed native applications as search parameters. For example, each of the search query and the installed native applications may be configured to restrict a search space of the search (e.g., identify a subset of the function records included in the search data store 110, or further reduce the subset to generate the set of function records). For instance, the search system 100 may identify a plurality of function records included in the search data store 110 that each include an AAM that references one of the installed native applications, and select the set of function records from the plurality of function records based on the search query.

The search system 100 processes (e.g., scores) the identified function records. For example, the search system 100 may determine how well the identified function records match the received search query. The search system 100 may then select one or more AAMs from those of the identified function records that best match the search query. The search system 100 transmits the search results including the selected AAMs to the user device 102 that generated the search query. The search system 100 may also transmit additional data along with the AAMs, e.g., link data (e.g., text and/or images) to be included in one or more user selectable links generated by the user device 102 for the AAMs to display the search results to the user.

An AAM included in a function record includes data that causes a user device 102 to launch a native application and perform a function associated with the application. For example, the AAM included in the function record may be a string that includes a reference to the native application and indicates one or more operations for the user device 102 (e.g., the native application) to perform. As described herein, the function record may further include a function ID, e.g., a string that uniquely identifies the function record among other function records included in the search data store 110, and ASI, which may include data that describes an application state into which the native application is set according to the AAM of the function record. Function IDs, ASI, and AAMs that may be included in function records are described in greater detail with reference to FIGS. 4A-4B and 8A-8B.

In some implementations, a function record (e.g., the function record 400A of FIG. 4A) may include multiple different AAMs. In these examples, the multiple different AAMs may be associated with different editions of a native application. A native application edition (hereinafter, “application edition”) of a native application may refer to a particular implementation or variation of the application. For example, the application edition may refer to a version of the native application, such as a version 1.0 or 2.0 of the application (e.g., a free version, or a paid version). In other examples, the application edition may refer to an implementation of the native application for a specific platform, such as a specific OS.

The multiple different AAMs included in the function record may cause the corresponding application editions to launch and perform similar functions. Accordingly, the multiple different AAMs may cause the corresponding application editions to be set into similar application states. In one example, if the multiple different AAMs reference different editions of a native information retrieval application, the AAMs may cause the corresponding application editions to retrieve similar information. In another example, if the multiple different AAMs reference different editions of a native internet music player application, the AAMs may cause the corresponding application editions to play the same song.

In a specific example, a function record for a native application that retrieves restaurant information may include multiple different AAMs for multiple different application editions. Assuming that the function record is associated with a specific Mexican restaurant, the AAMs for the multiple different application editions may cause each application edition to retrieve information for the same specific Mexican restaurant. For example, a first of the AAMs may cause a first application edition (e.g., for a first OS) to retrieve information for the specific Mexican restaurant. A second of the AAMs may cause a second application edition (e.g., for a second OS) to retrieve information for the specific Mexican restaurant.

During some searches, the search system 100 may identify one or more function records that each include multiple different AAMs. In these cases, the search system 100 may process (e.g., score) the identified function records in the manner described above. For each identified function record including multiple different AAMs, the search system 100 may determine which of the AAMs to select from the function record and transmit to the user device 102. In some examples, the search system 100 may transmit each of multiple different AAMs of a particular identified function record to the user device 102 so that the user device 102 may determine which AAM to use. In other examples, the search system 100 may determine which of the multiple different AAMs to transmit to the user device 102 based on information included in a query wrapper received from the user device 102. For example, the search system 100 may select and transmit one or more of the AAMs that are likely to be compatible with the user device 102, e.g., based on an OS or device type associated with the user device 102.

In some implementations, a function record may also include a web access mechanism (WAM). The WAM may be a resource identifier that can be processed by a wide variety of user devices 102 running different operating systems. In some examples, the WAM may include a uniform resource locator (URL) (i.e., a web address) used with the hypertext transfer protocol (HTTP). For example, the WAM may be a URL that is optimized for a desktop website (e.g., a so-called “full” site), or a mobile device website.

A WAM (e.g., a URL) included in a function record may be used by a web browser of a user device 102 to access a web resource that includes similar information and/or performs similar functions as would be performed by a native application that receives an AAM of the function record. In a specific example, a WAM of a function record may direct a web browser of a user device 102 to a web version of a native application referenced in one or more AAMs also included in the function record. For example, if one or more AAMs included in a function record for a specific Mexican restaurant cause each corresponding application edition to retrieve information for the specific Mexican restaurant, a WAM also included in the function record may direct a web browser of a user device 102 to a web page entry for the specific Mexican restaurant.

During some searches, the search system 100 may identify one or more function records that each include one or more AAMs and a WAM. In these cases, the search system 100 may process (e.g., score) the identified function records in the manner described above. For each identified function record including one or more AAMs and a WAM, the search system 100 may determine whether to transmit the WAM and/or the AAM(s) to the user device 102. In some examples, the search system 100 may transmit the WAM and each of the AAM(s) to the user device 102 so that the user device 102 can determine which of the access mechanisms to use. In one example, the user device 102 may generate a user selectable link for each of one or more of the AAM(s) that reference a native application that is installed on the user device 102 and are compatible with (e.g., an OS, or a device type of) the user device 102. In this example, the user device 102 may discard the WAM and any remaining ones of the AAM(s). In another example, the user device 102 may determine that none of the AAM(s) references an installed native application and/or is compatible with the user device 102. In this example, the user device 102 may discard the AAM(s), generate a user selectable link for the WAM, and, upon a user selecting the link, use a web browser of the user device 102 to access a web resource identified in the WAM. In other examples, the search system 100 may determine whether to transmit any of the WAM and the AAM(s) to the user device 102. In one example, the search system 100 may transmit those of the AAM(s) that reference installed native applications and/or are likely to be compatible with the user device 102 to the user device 102. The user device 102 may generate user selectable links for the transmitted AAM(s). In this example, the search system 100 may refrain from transmitting the WAM and any remaining ones of the AAM(s) to the user device 102. In another example, if the search system 100 determines that none of the AAM(s) references an installed native application and/or is likely to be compatible with the user device 102, the search system 100 may refrain from transmitting the AAM(s) to the user device 102. Instead, in this example, the search system 100 may transmit the WAM to the user device 102. The user device 102 may generate a user selectable link for the WAM, and, upon a user selecting the link, use a web browser of the user device 102 to access a web resource identified in the WAM.

In some implementations of the search system 100, a function record (e.g., the function record 400A of FIG. 4A) may include a quality score. The quality score may be a number used by the search system 100 to generate a result score for the function record. For example, the quality score may be a record scoring feature input into one or more machine-learned models used to generate the result score, as described hereinafter.

The quality score may be determined based on metrics associated with a person, place, or thing described in the function record. For example, the quality score may be based on popularity of the place described in the function record and/or ratings (e.g., user ratings) of the place described in the function record. In another example, if the function record describes a song, the quality score may be based on popularity of the song described in the function record and/or ratings (e.g., user ratings) of the song described in the function record. The quality score may also be determined based on measurements associated with the function record. For example, the quality score may be determined based on data indicating how often the function record is retrieved during a search and how often access mechanisms (e.g., an AAM, a WAM, and/or an application download address) of the function record are selected by a user.

The user device(s) 102 can be any one or more computing devices that are capable of providing search queries to the search system 100. The user device(s) 102 may include, but are not limited to, smart phones, tablet computers, laptop computers, and desktop computers. The user device(s) 102 may also include other computing devices having other form factors, such as computing devices included in vehicles, gaming devices, televisions, or other appliances (e.g., networked home automation devices and home appliances).

The user device(s) 102 may use a variety of different operating systems. In an example where a user device 102 is a mobile device, the user device 102 may run an OS including, but not limited to, ANDROID® developed by Google Inc., IOS® developed by Apple Inc., or WINDOWS PHONE® developed by Microsoft Corporation. Accordingly, the OS 222 running on the user device 102 as depicted in FIG. 2 may include one of ANDROID®, IOS®, or WINDOWS PHONE®. In an example where a user device 102 is a laptop or desktop computing device, the user device 102 may run an OS including, but not limited to, MICROSOFT WINDOWS® developed by Microsoft Corporation, MAC OS® developed by Apple Inc., or LINUX® (LINUX® is the registered trademark of Linus Torvalds in the U.S. and other countries). The user device(s) 102 may also access the search system 100 while running operating systems other than those operating systems described above, whether presently available or developed in the future.

The user device(s) 102 can communicate with the search system 100 via the network 106. In some examples, a user device 102 may communicate with the search system 100 using a native application installed on the user device 102 (e.g., the search application 226 depicted in FIG. 2). In general, a user device 102 may communicate with the search system 100 using any application that can transmit search queries to the search system 100. In some examples, a user device 102 may run an application that is dedicated to interfacing with the search system 100, such as an application dedicated to searches (e.g., the search application 226). In other examples, a user device 102 may communicate with the search system 100 using a more general application, such as a web browser application (e.g., the web browser 224 depicted in FIG. 2). The application run by a user device 102 to communicate with the search system 100 may display a search field (e.g., the search field 202 of FIG. 2) within a GUI into which a user of the user device 102 may enter search queries. The user may enter the search queries using a touchscreen or physical keyboard, a speech-to-text program, or other form of user input.

A user device 102 may receive search results from the search system 100 that are responsive to the search query transmitted by the user device 102 to the search system 100. The user device 102 may be running a search application (e.g., the search application 226) including a GUI that displays the search results received from the search system 100. For example, the user device 102 may use the search application used to transmit the search query to the search system 100 to also display the received search results to the user on the user device 102.

The GUI of the search application running on the user device 102 may display the search results to the user in a variety of different ways, depending on what information is transmitted to the user device 102 as part of the search results. In examples where the search results include one or more AAMs, the search system 100 may transmit the AAMs to the user device 102 along with additional data to be displayed within one or more user selectable links generated using the AAMs. In some examples, the GUI may display the search results to the user as a list of the user selectable links including text and images. The text and images included in the user selectable links may include names of native applications referenced by the AAMs, text describing the AAMs, images associated with the native applications (e.g., application icons), and images associated with the application states (e.g., application screen images) specified by the AAMs.

In some examples, the GUI may display the search results as a list of user selectable links (e.g., the links 218-1, 218-2, and 220-1 . . . 220-6 depicted in FIG. 2) arranged under the search field into which the user entered the search query. The user device 102 may arrange the user selectable links in order by result scores associated with the links. In other words, the user device 102 may arrange the user selectable links in order by the result scores associated with the AAMs used to generate the links. In some examples, the user device 102 may group multiple user selectable links that are related to the same native application.

In some examples, the user device(s) 102 may communicate with the search system 100 via a partner computing system (not illustrated). The partner computing system may be a computing system of a third party that may leverage the search functionality of the search system 100. The partner computing system may belong to a company or organization other than that which operates the search system 100. Example third parties which may leverage the functionality of the search system 100 may include, but are not limited to, internet search providers and wireless communications service providers. The user device(s) 102 may send search queries to the search system 100 and receive search results via the partner computing system. The partner computing system may provide a user interface to the user device(s) 102 in some examples and/or modify the search experience provided on the user device(s) 102.

The data source(s) 104 shown in FIG. 1 may be sources of data which the search system 100 may use to generate and update the search data store 110. For example, the search system 100 may use the data to update one or more databases, indices, tables, files, or other data structures included in the search data store 110. The search system 100 may generate new function records and update existing function records based on data retrieved from the data source(s) 104. Although not illustrated in FIG. 1, the search system 100 may include modules that generate new function records and update existing function records based on the data retrieved from the data source(s) 104. In some examples, some data included in the search data store 110 may be manually generated by a human operator.

The data source(s) 104 may include a variety of different data providers. For example, the data source(s) 104 may include data from application developers, such as application developers' websites and data feeds provided by application developers. The data source(s) 104 may also include operators of digital distribution platforms configured to distribute applications to user devices 102. The data source(s) 104 may further include other websites, such as websites that include web logs (i.e., blogs), application review websites, or other websites including data related to applications. Additionally, the data source(s) 104 may include social networking sites, such as “FACEBOOK®” by Facebook, Inc. (e.g., Facebook posts) and “TWITTER®” by Twitter, Inc. (e.g., text from tweets). The data source(s) 104 may also include online databases including data related to movies, television programs, music, and restaurants. The data source(s) 104 may also include additional types of data sources in addition to the data sources described above. Different data sources may have their own content and update rate.

The search system 100 retrieves data from one or more of the data source(s) 104. The data retrieved from the data source(s) 104 can include any type of data related to application functionality and/or application states. The search system 100 generates function records based on the data retrieved from the data source(s) 104. In some examples, some or all of the data included in the function records (e.g., ASI) is manually generated by a human operator. The data included in the function records may also be updated over time so that the search system 100 provides up-to-date search results.

As described above, the user device(s) 102, the search system 100, and the data source(s) 104 may communicate with one another via the network 106. The network 106 may include various types of networks, such as a wide area network (WAN) and/or the Internet. Although the network 106 may represent a long range network (e.g., Internet or WAN), in some implementations, the network 106 may include a shorter range network, such as a local area network (LAN). In some implementations, the network 106 uses standard communications technologies and/or protocols. Thus, the network 106 can include links using technologies such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), HTTP, the simple mail transfer protocol (SMTP), the file transfer protocol (FTP), etc. The data exchanged over the network 106 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs). Internet Protocol security (IPsec), etc. In other examples, the network 106 can use custom and/or dedicated data communications technologies instead of, or in addition to, the ones described above.

FIG. 2 illustrates an example user device 102 in communication with the search system 100 via the network 106 (not illustrated in FIG. 2). In the example of FIG. 2, the user device 102 is a smart phone computing device. The search system 100 is configured to receive a search query 200 from the user device 102 and perform a search for one or more function records included in the search data store 110 based on the received search query 200. The function records include one or more AAMs that can be used by the user device 102 to access different functions for a variety of different native applications (e.g., the one or more native applications 228 shown in FIG. 2) installed on the user device 102. The search system 100 selects the AAMs from the function records and transmits search results 230 that include the AAMs to the user device 102.

The user device 102 may generate one or more user selectable links, or links, based on the received search results 230 (e.g., the links 218-1, 218-2, and 220-1 . . . , 220-6 depicted in FIG. 2) and display the links to a user of the user device 102. Each user selectable link displayed to the user may include one of the AAMs included in the search results 230. The user may select a particular user selectable link displayed on the user device 102. In response to the user selecting the user selectable link, the user device 102 may launch a native application referenced by the AAM associated with the link and perform one or more operations indicated by the AAM.

As described herein, the search system 100 is configured to receive search queries 200 from one or more of the user device(s) 102 via the network 106. A search query 200 may include text, numbers, and/or symbols (e.g., punctuation) entered into a user device 102 by a user. For example, as illustrated in FIG. 2, the user may have entered a search query “Late night diners” 200 into a search field (e.g., a “search box”) 202 of a GUI of a search application 226 executing on the user device 102. The user may have entered the search query 200 using a user interface such as, e.g., a touchscreen keypad, a mechanical keypad, and/or via speech recognition. The user may have caused the user device 102 to transmit the search query 200 to the search system 100 by selecting (e.g., touching, or clicking on) a search button 204 also included in the GUI. As described herein, in some examples, the search application 226 may be a native application dedicated to search (e.g., one of the native application(s) 228), or a more general application, such as a web browser application (e.g., the web browser 224) included on the user device 102.

In some examples, the user device 102 may transmit additional data to the search system 100 along with the search query 200. The search query 200 and the additional data may be referred to as a query wrapper. The query wrapper may include data associated with the search query 200, such as geo-location data 206 (e.g., indicating a location of the user device 102), platform data 208 (e.g., indicating a version of the OS 222, a device type, and/or a version of the web browser 224 associated with the user device 102), data indicating an identity of the user (e.g., a username), partner specific data, and other data. The user device 102 transmits the query wrapper to the search system 100, as shown in FIG. 2. The search system 100 can use the search query 200 and/or the additional data included in the query wrapper to generate search results 230.

To generate the search results 230, the search system 100 performs a search for one or more function records included in the search data store 110 in response to receiving the search query 200 from the user device 102. Specifically, in the example of FIG. 2, the search system 100 may use the search query 200 as a search parameter to identify the function records within the search data store 110. In this example, the search system 100 generates so-called “unfiltered” search results 230 that include one or more AAMs 210 selected from the function records identified during the search. In other words, in the example of FIG. 2, each of the AAM(s) 210 may reference a native application that is installed, or is available, on the user device 102 (e.g., one of the native application(s) 228) or is not installed, or is unavailable, on the user device 102. In some examples, the search system 100 generates one or more result scores 212 for the AAM(s) 210 selected from the identified function records. For example, each AAM 210 may be associated with a result score 212 that indicates a rank of the AAM 210 relative to one or more other ones of the AAM(s) 210. The search system 100 may transmit the result score(s) 212 to the user device 102 along with the AAM(s) 210 as part of the unfiltered search results 230, as shown in FIG. 2.

In some examples, the search system 100 may transmit additional data to the user device 102 along with the AAM(s) 210 and the result score(s) 212. For example, as also shown in FIG. 2, the search system 100 may transmit link data 214 (e.g., text and/or images). The link data 214 may refer to data that is to be included in user selectable links generated on the user device 102 using the AAM(s) 210. The user device 102 displays the user selectable links to the user. Each user selectable link may be associated with one of the AAM(s) 210, such that when the user selects a particular user selectable link, the user device 102 launches a native application referenced by the corresponding AAM 210 and sets the application into an application state specified by the AAM 210. The user may select the user selectable link by touching (e.g., tapping) or clicking on the link, as described herein.

In other examples, as also depicted in FIG. 2, the search system 100 may optionally transmit one or more AppIDs 216 to the user device 102 as part of the unfiltered search results 230. In these examples, each of the AppID(s) 216 may indicate a native application associated with the unfiltered search results 230. Specifically, each AppID 216 may be associated with one of the AAM(s) 210 and indicate (e.g., via a name, a number, or another designator or identifier of) a native application that is referenced by the AAM 210. Each AppID 216 may be any suitable numeric or alphanumeric string. In some examples, each AppID 216 may be assigned to the corresponding native application by a digital distribution platform that offers the application, by the search system 100, or by another system or device. In some implementations, each AppID 216 may be, or include, a name of the corresponding native application.

As described herein, upon receiving the AppID(s) 216 from the search system 100, the user device 102 may use the AppID(s) 216 to generate one or more user selectable links based on the received unfiltered search results 230. Specifically, the user device 102 may first determine one or more native applications that are installed on the user device 102 (e.g., the native application(s) 228). For example, the user device 102 may determine an AppID for each of the installed native applications. Each such AppID may be similar in content, format, and function to each of the AppID(s) 216 described above. Subsequently, for each of the AAM(s) 210, the user device 102 may determine whether the AAM 210 references one of the installed native applications using the corresponding one of the AppID(s) 216. For example, the user device 102 may compare the AppID 216 for the AAM 210 to each of one or more of the AppIDs determined for the installed native applications. The user device 102 may then generate and display a user selectable link for each of the AAM(s) 210 that references one of the installed native applications (e.g., one of the native application(s) 228) and refrain from generating or displaying user selectable links for any of the AAM(s) 210 that do not reference one of the installed native applications, as described herein.

In still other examples (not shown in FIG. 2), the search system 100 may transmit one or more WAMs to the user device 102 as part of the unfiltered search results 230. Each WAM may include a web address that is accessible by the user device 102 via the web browser 224. In examples where the search system 100 transmits WAMs to the user device 102, the search system 100 may transmit additional data (e.g., text and/or images) to be included in user selectable links associated with the WAMs. When the user selects a user selectable link associated with a WAM, the user device 102 may launch the web browser 224 and cause the web browser 224 to perform a function indicated in the WAM.

FIG. 2 illustrates the manner in which those of the AAM(s) 210 included in the unfiltered search results 230 that reference the installed native applications may be displayed to the user on the user device 102. As shown in FIG. 2, those of the AAM(s) 210 that reference the installed native applications are displayed as user selectable links, or links, 218-1, 218-2, 220-1, 220-2, 220-3, 220-4, 220-5, and 220-6. Each link includes the link data 214 associated with the corresponding one of the AAM(s) 210. For example, each link includes an image (e.g., an application icon) and text (e.g., application name) that describe a native application and an application state within the application (e.g., “IHOP,” “Denny's,” and “Taco Bell” entries within the native application “YELP®” by Yelp, Inc. (hereinafter, “Yelp”)) that are specified by the one of the AAM(s) 210 and that correspond to the link. Each link may be associated with one of the AAM(s) 210 such that, when the user selects the link, the user device 102 launches a native application associated with the link and referenced by the AAM 210 and sets the application into an application state associated with the link and specified by the AAM 210. As described herein, in some examples, the links may be arranged for the user (e.g., within a list) based on the result scores 212 associated with the corresponding ones of the AAM(s) 210. Moreover, in other examples, multiple links that are each associated with the same native application (e.g., Yelp) may be combined together when displayed to the user. For example, as shown in FIG. 2, the Yelp links 220-1, 220-2, and 220-3 are grouped together under a Yelp header 218-1. In other examples, links may be mixed, or distributed, instead of grouped.

In the example of FIG. 2, each of the links 220-1 . . . 220-6 includes one of the AAM(s) 210 received from the search system 100 in response to the search query 200. Specifically, as described herein, each link includes one of the AAM(s) 210 that specifies an application state within a native application that is installed on the user device 102. In other words, although the AAM(s) 210 may include one or more AAMs that each specify an application state within a native application that is not installed on the user device 102, none of these AAMs is used to generate any of the links 220-1 . . . 220-6. As such, in the example of FIG. 2, each of the links 220-1 . . . 220-6 is associated with an application state of one of the installed native applications. In this manner, by generating and displaying the links 220-1 . . . 220-6 for those of the AAM(s) 210 that reference the installed native applications, and by refraining from generating or displaying links for those of the AAM(s) 210 that do not reference the installed native applications (i.e., that reference native applications that are not installed on the user device 102), the user device 102 transforms the unfiltered search results 230 that may be associated with both the installed native applications and native applications that are not installed on the user device 102 into so-called “filtered” search results 230 that are associated with the installed native applications. As a result, the user may access any of the filtered search results 230 displayed on the user device 102 (i.e., the links 220-1, 220-2, 220-3, 220-4, 220-5, and 220-6) without first installing a native application that is not installed, or is unavailable, on the user device 102.

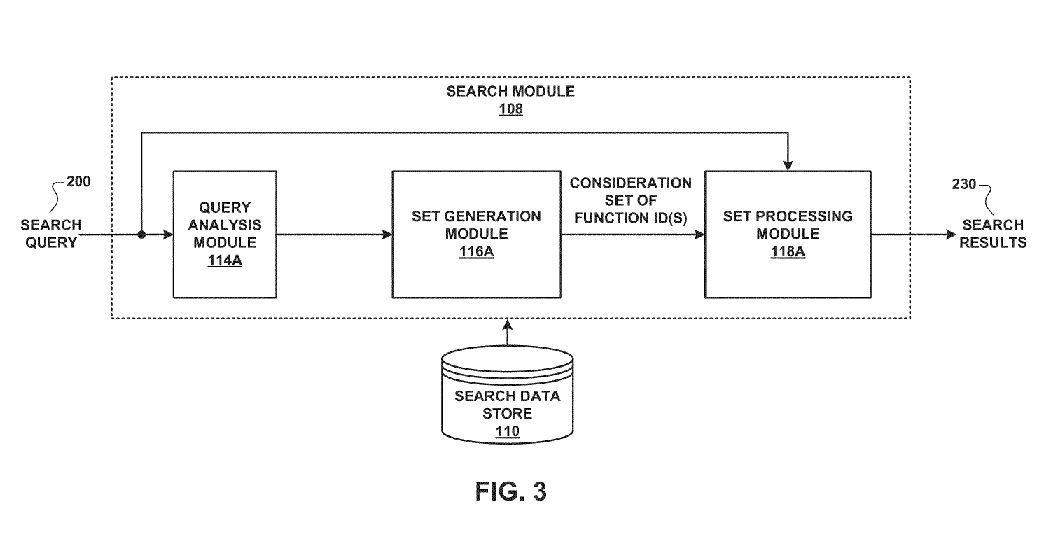

FIG. 3 illustrates a functional block diagram of an example search module 108 that may be included in the search system 100 according to the present disclosure. FIG. 3 also shows an example search data store 110 that may be included in the search system 100 according to this disclosure. The search module 108 of FIG. 3 includes a query analysis module 114A, a consideration set generation module 116A (hereinafter, the “set generation module 116A”), and a consideration set processing module 118A (hereinafter, the “set processing module 118A”). In the example of FIG. 3, the query analysis module 114A receives a query wrapper that includes a search query 200 from a user device 102. The query analysis module 114A analyzes the received search query 200. For example, to analyze the search query 200, the query analysis module 114A may perform one or more of tokenization, filtering, stemming, synonymization, and stop word removal with respect to the search query 200. The set generation module 116A identifies one or more function records included in the search data store 110 based on the received (e.g., analyzed) search query 200. The identified function records may be referred to herein as a “consideration set.” In some examples, the consideration set may be represented using one or more function IDs of the identified function records. The set processing module 118A processes (e.g., scores) the consideration set to generate search results 230 that include one or more AAMs selected from the identified function records of the consideration set. The set processing module 118A transmits the search results 230 including the AAMs to the user device 102 that generated the search query 200.

As described herein, the set generation module 116A identifies the consideration set of function records included in the search data store 110 based on the search query 200. In some examples, the set generation module 116A may identify the function records of the consideration set based on one or more matches between one or more terms of the search query 200 and one or more terms included in the function records. For example, the set generation module 116A may identify the function records based on one or more matches between one or more tokens generated by the query analysis module 114A using the search query 200 and one or more words included in the ASI and/or function IDs of the function records.

As also described herein, the set processing module 118A processes the consideration set to generate the search results 230 that include one or more AAMs. In some examples, to process the consideration set, the set processing module 118A generates scores for the functions records of the consideration set. The scores associated with the function records may be referred to herein as “result scores.” Accordingly, in some examples, each function record of the consideration set may have a corresponding result score. The set processing module 118A may then select one or more function records from the consideration set based on the result scores associated with the function records. For example, the set processing module 118A may select one or more function records of the consideration set that have the highest one or more result scores. The set processing module 118A then selects one or more AAMs from the selected function records (e.g., the highest-scoring function records) and transmits the selected AAMs to the user device 102 as part of the search results 230. The set processing module 118A may also transmit the result scores associated with the selected AAMs to the user device 102, e.g., as part of the search results 230. For example, a selected AAM may be associated with a result score of a function record from which the AAM was selected.

The information conveyed by the search results 230 may depend on how the result scores are calculated by the set processing module 118A. For example, the result scores may indicate the relevance of an application function or application state to the search query 200, the popularity of the application function or state, or other properties of the application function or state, depending on what parameters the set processing module 118A uses to score the function records of the consideration set.

The set processing module 118A may generate result scores for function records in a variety of different ways. In some implementations, the set processing module 118A generates a result score for a function record based on one or more scoring features. The scoring features may be associated with the function record and/or the search query 200. A function record scoring feature (hereinafter, “record scoring feature”) may be based on any data associated with a function record. For example, record scoring features may be based on any data included in ASI of a function record. Example record scoring features include a quality score and whether a function record includes an AAM that leads to a default state, or a deeper application state. A query scoring feature may include any data associated with the search query 200. Example query scoring features include a number of words in the search query 200, popularity of the search query 200, and expected frequency of words in the search query 200. A record-query scoring feature may include any data that may be generated based on data associated with both a function record and the search query 200 that resulted in identification of the function record by the set generation module 116A. Example record-query scoring features include parameters that indicate how well terms of the search query 200 match terms of ASI of the identified function record. The set processing module 118A may generate a result score for a function record based on at least one of the record scoring features, the query scoring features, and the record-query scoring features described above.

The set processing module 118A may determine a result score for a function record based on one or more of the scoring features listed herein and/or additional scoring features not explicitly listed. In some examples, the set processing module 118A may include one or more machine-learned models (e.g., a supervised learning model) configured to receive one or more scoring features. The one or more machine-learned models may generate result scores based on at least one of the record scoring features, the query scoring features, and the record-query scoring features. For example, the set processing module 118A may pair the search query 200 with each function record and calculate a vector of features for each (query, record) pair. The vector of features may include one or more record scoring features, one or more query scoring features, and one or more record-query scoring features. The set processing module 118A may then input the vector of features into a machine-learned regression model to calculate a result score for the function record. In some examples, the machine-learned regression model may include a set of decision trees (e.g., gradient-boosted decision trees). In other examples, the machine-learned regression model may include a logistic probability formula. In still other examples, the machine-learned task described above can be framed as a semi-supervised learning task, where a minority of training data is labeled with human-curated scores, and the rest of the training data is used without human-curated labels.

The result scores associated with the AAMs may be used in a variety of different ways. In some examples, the result scores associates with AAMs may be used to rank the AAMs within a list. In these examples, a higher (e.g., larger) result score may indicate that the corresponding AAM (e.g., the associated application state or function of a native application) is more relevant to the user's search query 200 than another AAM having a lower (e.g., smaller) result score. In examples where the search results 230 are displayed on the user device 102 as a list of user selectable links, the user selectable links for AAMs associated with larger result scores may be listed closer to the top of the list (e.g., near the top of the screen). In these examples, user selectable links for AAMs having lower result scores may be located farther down the list (e.g., off screen) and may be accessed by scrolling down a screen of the user device 102. In some examples, as illustrated in FIG. 2, the user device 102 may group together one or more user selectable links that are associated with the same native application.

FIGS. 4A-4B illustrate example function records 400A and 400B, respectively, that may be included in the search data store 110 of the present disclosure. The function record 400A of FIG. 4A includes a function ID 402A, ASI 404A, and one or more AAMs 406A. The function record 400A may include data related to a function of a native application and/or a state of the native application resulting from performance of the function. The search data store 110 may include one or more function records each having a similar structure as that of the function record 400A. Put another way, the search data store 110 may include one or more function records each having a function ID, ASI, and one or more AAMs.

The function ID 402A may be used to identify the function record 400A among other function records included in the search data store 110. The function ID 402A may be a string of alphabetic, numeric, and/or symbolic characters (e.g., punctuation marks) that uniquely identify the function record 400A in which the function ID 402A is included. In some examples, the function ID 402A may describe a function and/or an application state in human-readable form. For example, the function ID 402A may include a name of a native application referenced in the AAM(s) 406A. Additionally, or alternatively, the function ID 402A may be a human-readable string that describes a function performed according to the AAM(s) 406A and/or an application state resulting from performance of the function according to the AAM(s) 406A. In some examples, the function ID 402A may include a string in the format of a URL of a WAM also included in the function record 400A, which may uniquely identify the function record 400A.

In a more specific example, if the function record 400A describes a function of Yelp, the function ID 402A may include the name “Yelp” along with a description of an application state described in the ASI 404A. For example, if the function record 400A describes an entry within Yelp for the restaurant “The French Laundry®” (hereinafter, “The French Laundry”), the function ID 402A may be “Yelp—The French Laundry.” In an example where the function ID 402A includes a string in the format of a URL, the function ID 402A may include the string “www.yelp.com/bizthe-french-laundry-yountville-2?ob=1” to uniquely identify the function record 400A among other function records included in the search data store 110.

The ASI 404A may include data that describes an application state into which a native application is set according to the AAM(s) 406A. Additionally, or alternatively, the ASI 404A may include data that describes a function performed according to the AAM(s) 406A. The ASI 404A may include a variety of different types of data. For example, the ASI 404A may include structured, semi-structured, and/or unstructured data. The ASI 404A may be extracted or inferred from documents retrieved from the data source(s) 104. In some examples, the ASI 404A may include data that is manually generated. The ASI 404A may also be updated so that up-to-date search results 230 can be provided in response to a user search query 200.

In some examples, the ASI 404A includes data that is presented to a user when a native application referenced by the AAM(s) 406A is in an application state defined by the AAM(s) 406A. For example, the ASI 404A may include data that describes a state of the native application after the user device 102 has performed one or more operations indicated by the AAM(s) 406A. In one example, if the function record 400A is associated with a shopping application, the ASI 404A may include data that describes products (e.g., names and prices) that are shown when the application is set into an application state defined by the AAM(s) 406A. In another example, if the function record 400A is associated with a music player application, the ASI 404A may include data that describes a song (e.g., name and artist) that is played when the application is set into an application state defined by the AAM(s) 406A.

The type(s) of data included in the ASI 404A may depend on the type(s) of information associated with an application state and/or functionality defined by the AAM(s) 406A. In one example, if the function record 400A is for a native application that provides reviews of restaurants, the ASI 404A may include information (e.g., text and numbers) related to a restaurant, such as a category of the restaurant, reviews of the restaurant, and a menu for the restaurant. In this example, the AAM(s) 406A may cause the native application to launch and retrieve information for the restaurant. In another example, if the function record 400A is for a native application that plays music, the ASI 404A may include information related to a song, such as a song name, an artist name, lyrics, and listener reviews. In this example, the AAM(s) 406A may cause the native application to launch and play the song described in the ASI 404A.

The AAM(s) 406A may include an ARI and/or one or more operations for the user device 102 to perform. For example, the ARI may be a string having an application-specific scheme. The ARI may include a reference to a native application and indicate one or more operations for the user device 102 (e.g., the native application) to perform. For example, the ARI may include the reference to the native application, a domain name, and a path to be used by the native application to retrieve and display information to the user.

An example ARI for the native application “OPENTABLE®” by OpenTable, Inc. (hereinafter, “OpenTable”) on the ANDROID® OS is “vnd.opentable.deeplink:/!opentable.com/restaurant/profile?rid=88333&refid=1.” A portion of the example ARI references OpenTable. For example, the substring “vnd.opentable.deeplink” of the ARI references OpenTable. The example ARI also indicates one or more operations for OpenTable to perform. For example, OpenTable may retrieve and display information included in the ARI domain and path defined by the substring “opentable.com/restaurant/profile?rid=88333&refid=1.” In response to receiving the ARI, the user device 102 may launch OpenTable and display information retrieved from a location indicated in the ARI. The ARI may be provided by a developer of OpenTable in some examples.

In some examples, the ARI may be an application-specific resource identifier that is defined by a developer of the native application referenced by the ARI. In these examples, the search application 226 may receive the ARI, and the OS 222 may send the ARI to the native application referenced by the ARI. The native application may then launch and be set, or configured, into an application state specified by the ARI.

In some examples, an application state or function of a native application may not be accessible using an ARI. As one example, the application state or function may not include a corresponding ARI that the application may use to access the application state or perform the function. As another example, the native application may not be configured to receive ARIs. In these examples, an AAM (e.g., one of the AAM(s) 406A) that references the native application may include one or more operations that cause the native application to access the application state or perform the function that may not otherwise be accessible using an ARI. For example, the search application 226 may receive the operations and execute the operations to set the native application into the desired application state (e.g., causing the native application to perform the desired function). In a specific example, the operations may cause the native application to launch and perform one or more additional steps after launching. For example, using one or more operations included in the AAM, the search application 226 may trigger the native application to cause the application to launch, and then wait for a period of time for the application to launch. Then, the search application 226 may perform one or more additional operations included in the AAM, such as issuing a search instruction to the native application.

In other examples, the native application may be configured to directly (i.e., without the assistance of the search application 226) receive and perform the operations included in the AAM. In these examples, the native application may launch according to one or more operations included in the AAM. The launched native application may then perform one or more additional operations included in the AAM.

In some examples, the AAM(s) 406A may include one or more operations for the user device 102 to perform in addition to the operations indicated by the ARI. The search application 226 executing on the user device 102, the OS 222 of the user device 102, and/or the native application referenced by the AAM(s) 406A (e.g., one of the native application(s) 228 installed on the user device 102) may perform the additional operations to set the native application into an application state specified by the AAM(s) 406A. In some examples, the operations may be included in a script. Examples of the operations may include, but are not limited to, launching a native application, waiting for a native application to start, creating and sending a search request to a server associated with a native application, setting a current geo-location in a native application, making a restaurant reservation, sending a text message, and adding an appointment to a calendar.

In some examples, the AAM(s) 406A may not include an ARI. Instead, the AAM(s) 406A may include one or more operations that reference a native application. The operations may be performed by the user device 102. The operations may include one or more instructions for at least one of the search application 226, the OS 222, and the native application referenced by the AAM(s) 406A. In response to selection of the AAM(s) 406A, the user device 102 may perform the operations. In some examples, the operations may be included in a script.

The AAM(s) 406A may further include edition information that indicates one or more native application editions with which the AAM(s) 406A are compatible. For example, the edition information may indicate an OS and/or a device type with which each of one or more of the AAM(s) 406A is compatible. In some examples, using the edition information, the search system 100 may determine which, if any, of the AAM(s) 406A are compatible with (e.g., the OS 222, and/or a device type of) the user device 102 and should therefore be transmitted to the user device 102 as part of search results 230, as described herein. For example, the search system 100 may transmit those of the AAM(s) 406A to the user device 102 that the search system 100 determines are compatible with the user device 102 using the edition information. As also described herein, in some examples, the search system 100 may transmit those of the AAM(s) 406A that are both compatible with the user device 102 and reference native applications that are installed on the user device 102. In any case, the user device 102 may generate user selectable links for the transmitted AAM(s) 406A. In other examples, the search system 100 may transmit the AAM(s) 406A and the edition information to the user device 102. In these examples, using the edition information, the user device 102 may identify those of the AAM(s) 406A that are compatible with the user device 102 (e.g., those of the AAM(s) 406A that are both compatible with the user device 102 and reference installed native applications) and generate user selectable links for the identified AAM(s) 406A, as also described herein.

In examples where the function record 400A also includes a WAM, the search system 100 may transmit the WAM to the user device 102 along with, or in place of, the AAM(s) 406A, as described herein. In other examples, the function record 400A may also include one or more application download addresses that each specify a location (e.g., a digital distribution platform) from which a native application referenced by each of one or more of the AAM(s) 406A may be downloaded. In these examples, the search system 100 may transmit the application download addresses to the user device 102 along with the AAM(s) 406A, the WAM, and/or the edition information. In some examples, upon determining that a particular one of the AAM(s) 406A received by the user device 102 references a native application that is not installed on the user device 102, the user device 102 may generate a download and install user selectable link that includes one of the application download addresses that is associated with the native application (e.g., with the particular one of the AAM(s) 406A) and display the link to a user of the user device 102. In response to the user selecting the link, the user device 102 may download and install the native application using the application download address, launch the native application, and set the native application into an application state specified by the particular one of the AAM(s) 406.

As described herein, a single native application may provide a variety of different functionalities. For example, a restaurant reservation application can access reviews for a variety of different restaurants and set up reservations at a variety of different restaurants. Similarly, a travel application can book hotels, book flights, and provide reviews for different travel destinations. The different functionalities associated with a single native application may be accessed using a plurality of different AAMs. For example, with respect to the restaurant reservation application, the search data store 110 may include multiple function records having different AAMs for accessing restaurant reviews and setting up reservations within the same application. Similarly, with respect to the travel application, the search data store 110 may include multiple function records having different AAMs for booking hotels or flights and accessing reviews for different travel destinations within the same application.

AAMs for a single native application may vary in complexity. In some examples, the AAMs may cause the native application to launch (e.g., the AAMs may instruct the OS 222 to launch the native application) and then perform one or more additional operations after launching, as described above. In other examples, the AAMs may cause the native application to launch into a default state (e.g., a default homepage) without performing any additional operations. A function record including an AAM that causes a native application to launch into a default state may be thought of as a function record that is associated with the native application, but not with any particular application state of the application. A function record including such an AAM may include ASI describing the native application, instead of any particular application state of the application. For example, the ASI may include a name of a developer of the native application, a publisher of the application, a category (e.g., genre) of the application, a description of the application (e.g., a developer's description), and a price of the application. The ASI may also include security or privacy data about the application, battery usage of the application, and bandwidth usage of the application. The ASI may also include application statistics for the native application, which may refer to numerical data related to the application, e.g., a number of downloads, a download rate (e.g., downloads per month), a number of ratings, and a number of reviews associated with the native application.

FIG. 4B illustrates the function record 400B, which is associated with an application state of OpenTable. OpenTable is a restaurant-reservation application that allows users to search for restaurants and make restaurant reservations. OpenTable provides information about restaurants, including descriptions of restaurants and user reviews of the restaurants. The example function record 400B of FIG. 4B describes an application state of OpenTable in which OpenTable accesses information for a specific Denny's® restaurant located in San Jose, Calif.

The function record 400B includes a function ID “OpenTable—Denny's, 910 Saratoga Ave., San Jose, Calif. 95129” indicated at 402B, which may be used as a unique identifier to identify the function record 400B. In other examples, the function ID 402B may include a URL as a unique identifier for the function record 400B. For example, the function ID 402B may include the string “http://www.opentable.com/dennys-san-jose-11” as the unique identifier for the function record 400B. In some examples, such a function ID may also correspond to a WAM of a function record that includes the function ID. In other examples, the function ID 402B may be a string of characters, numbers, and/or symbols that are not presented in human-readable form.

The function record 400B also includes ASI 404B. The ASI 404B includes data fields for a restaurant category of the specific Denny's® restaurant, a description of the Denny®) restaurant, user reviews of the Denny's® restaurant, and additional data fields. The restaurant category field may include the text “breakfast” and “late night diners,” for example. The description field may include text that describes the Denny's@restaurant. The user reviews field may include text of user reviews for the Denny's*@restaurant. The additional data fields may include additional data for the Denny's® restaurant that may not fit within the other defined fields, such as a menu, prices, and operating hours for the restaurant.

The function record 400B also includes one or more AAMs 406B. The AAM(s) 406B may include a reference to OpenTable along with one or more operations to be performed by the user device 102. For example, as shown in FIG. 4B, the AAM(s) 406B may include an ARI and/or one or more operations that cause the user device 102 to access the entry for the specific Denny's® restaurant in OpenTable. An example of the ARI is the string “vnd.opentable.deeplink://opentable.com/restaurant/profile?rid=1180&refid=1.”

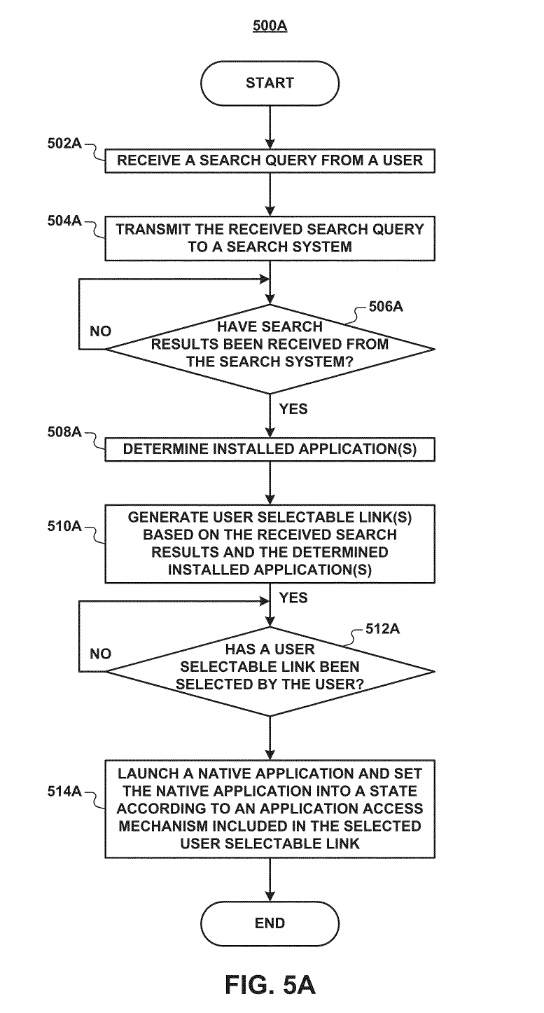

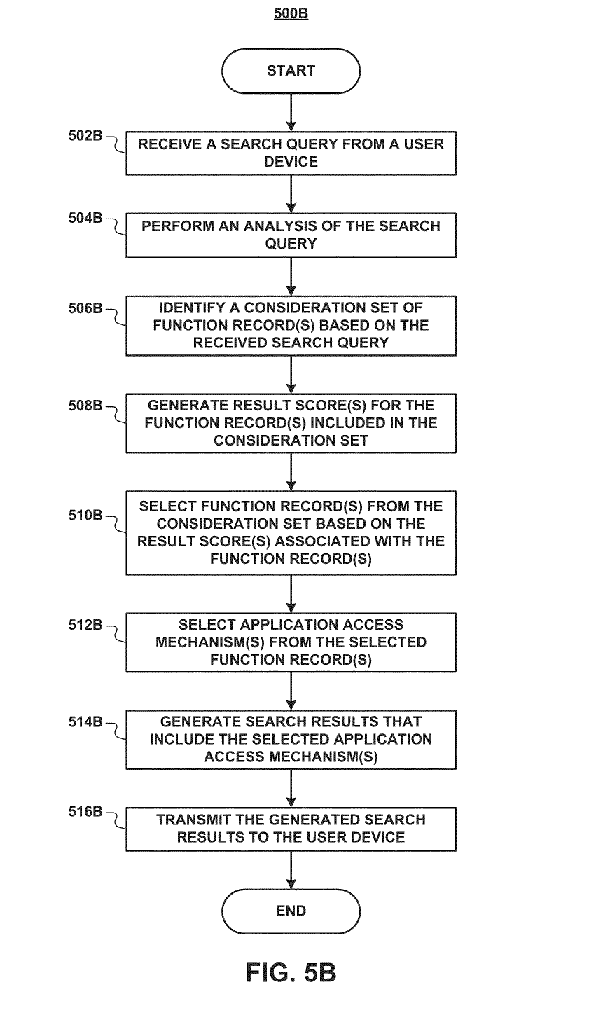

FIG. 5A is a flow diagram that illustrates an example method 500A for transmitting search queries 200 to the search system 100 using a user device 102, receiving search results 230 from the search system 100 at the user device 102 in response to transmitting the search queries 200, and displaying the search results 230 on the user device 102. In the example method 500A, displaying the search results 230 on the user device 102 includes displaying the search results 230 based on one or more native applications that are installed on the user device 102. The user device 102 described with reference to the method 500A includes a search application 226 (e.g., a native application, or a web-based application) that is configured to communicate with users of the user device 102 and with the search system 100. Specifically, the search application 226 is configured to generate a GUI that receives search queries 200 from the users, transmits the search queries 200 to the search system 100, receives search results 230 from the search system 100 in response to the transmitted search queries 200, and displays the received search results 230 to the users. The method 500A of FIG. 5A is described with reference to the search system 100 and the user device(s) 102 of FIGS. 1 and 2, as well as the various components thereof.

In block 502A, the search application 226 receives a search query 200 from a user of the user device 102. For example, the user may have entered the search query 200 into the GUI (e.g., into a search field 202 of the GUI) of the search application 226. In block 504A, the user device 102 transmits the received search query 200 to the search system 100. In block 506A, the user device 102 waits to receive search results 230 from the search system 100 in response to transmitting the search query 200. The method 500A continues in block 508A when the user device 102 receives the search results 230 from the search system 100.

In block 508A, the search application 226 determines one or more native applications that are installed on the user device 102. For example, to determine the installed native applications, the search application 226 may determine one or more AppIDs that each identify one of the applications, as described herein. In some examples, to determine the installed native applications, the search application 226 may poll the OS 222 of the user device 102 and receive an indication (e.g., an AppID) of each of the applications from the OS 222 in response to polling the OS 222. In other examples, to determine the installed native applications, the search application 226 may retrieve the indications (e.g., the AppID(s)) from a memory location within the user device 102, or from an external data store. In some examples, the search application 226 may determine the installed native applications at a different point in time (e.g., prior to receiving the search results 230 from the search system 100).

As described below with reference to the example method 500B of FIG. 5B, the search results 230 may include one or more AAMs that each reference a native application. In particular, each AAM may reference one of a native application that is installed on the user device 102, and a native application that is not installed on the user device 102. The search results 230 may also include a result score associated with each AAM, as described herein. The search results 230 may further include link data (e.g., text and/or images) for each AAM, as also described herein. In the method 500A, the search application 226 may generate a user selectable link for each of the AAMs that references an installed native application based on the received link data for the AAM. The search application 226 may then display the user selectable link in the GUI of the search application 226. The search application 226 may also arrange user selectable links generated for the AAMs that reference installed native applications within the GUI based on the received result scores associated with the AAMs (e.g., according to a numerical order of the received result scores). In the method 500A, the search application 226 may refrain from generating or displaying user selectable links for any of the AAMs that do not reference installed native applications.

Accordingly, in block 510A, the search application 226 generates one or more user selectable links based on the received search results 230 and based on the determined one or more installed native applications, in the manner described above. Stated another way, in block 510A, the search application 226 arranges the received search results 230 for display to the user as one or more user selectable links. As explained herein, the displayed search results 230 may include a user selectable link for each AAM included in the search results 230 that references one of the installed native applications. In this example, the displayed search results 230 may not include user selectable links for any AAMs included in the search results 230 that do not reference any of the installed native applications. In cases where the search results 230 may not include any AAMs that reference the installed native applications, the search application 226 may not generate or display any user selectable links to the user.

In block 512A, the search application 226 waits for the user to select one of the user selectable links. The method 500A continues in block 514A when the user selects (e.g., touches, or clicks on) one of the user selectable links displayed to the user. In block 514A, in response to the user selecting one of the user selectable links, the user device 102 launches a native application and sets the application into an application state according to an AAM included in the selected user selectable link. In other words, in block 514A, the user device 102 launches the native application referenced by the AAM associated with the selected user selectable link and performs one or more operations indicated by the AAM, as described herein.

FIG. 5B is a flow diagram that illustrates an example method 500B for generating search results 230 based on a received search query 200. The method 500B is described with reference to the search module 108 of FIGS. 1-3, as well as the various components thereof. In block 502B, the query analysis module 114A receives a search query 200 from one of the user device(s) 102. In block 504B, the query analysis module 114A performs an analysis of the received search query 200. For example, the query analysis module 114A may perform one or more of tokenization, filtering, stemming, synonymization, and stop word removal with respect to the search query 200, as described herein.

In block 506B, the set generation module 116A identifies a consideration set of one or more function records included in the search data store 110 based on the received search query 200 (e.g., based on an output of the query analysis module 114A). To identify the function records included in the consideration set based on the search query 200, the set generation module 116A may identify the function records based on one or more matches between one or more terms of the search query 200 and one or more terms of ASI included in the identified function records.

As one example, the set generation module 116A may identify the function records based on the search query 200 by performing a search of the search data store 110 using the search query 200 as a search parameter. In this example, the search data store 110 includes a plurality of function records that includes the identified function records. Also in this example, the search query 200 is configured to restrict a search space of the search. For example, the search query 200 may be configured to restrict the space of the search to include only a subset of the plurality of function records that corresponds to the identified function records. The subset may include only those function records of the plurality of function records whose function IDs and/or ASI include one or more terms of the search query 200, as described herein. As a specific example, to identify the function records based on the search query 200, the set generation module 116A may perform a search using Lucenec® information retrieval software developed by the Apache Software Foundation. In this example, the set generation module 116A may use the search query 200 as a search parameter of the search, e.g., as an input to the Lucene® information retrieval software.

In blocks 508B-510B, the set processing module 118A processes the consideration set, as described herein. Specifically, in block 508B, the set processing module 118A generates result scores for the function records included in the consideration set. In other words, in block 508B, the set processing module 118A generates a result score for each of the function records included in the consideration set. In block 510B, the set processing module 118A selects one or more function records from the consideration set based on the result scores associated with the selected function records. For example, the set processing module 118A may select one or more function records included in the consideration set that have the highest one or more result scores.

In block 512B, the set processing module 118A selects one or more AAMs from the selected function records. In block 514B, the set processing module 118A generates search results 230 that include the selected AAMs. In block 516B, the set processing module 118A transmits the generated search results 230 to the user device 102 that generated the search query 200.

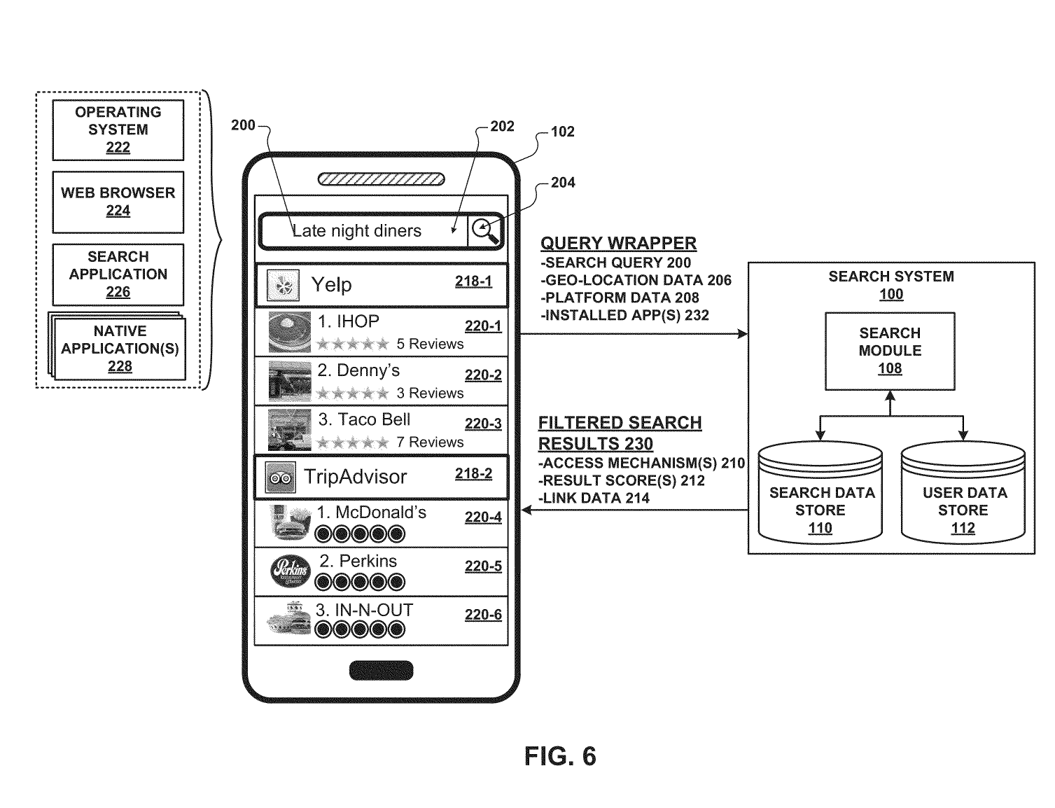

FIG. 6 illustrates another example user device 102 in communication with a search system 100 according to the techniques of this disclosure. The example of FIG. 6 is similar, although not identical, to the example of FIG. 2 described above. As such, in the example of FIG. 6, the user device 102 receives a search query “Late night diners” 200 from a user of the user device 102 (e.g., via a search field 202 of a GUI of the search application 226), transmits the search query 200 to the search system 100 as part of a query wrapper (e.g., upon the user selecting a search button 204 of the GUI), and receives search results 230 including one or more AAMs that are responsive to the search query 200 from the search system 100. In contrast to the example of FIG. 2, however, the user device 102 of FIG. 6 also transmits an indication of each of one or more native applications that are installed on the user device 102 (i.e., installed app(s) 232) to the search system 100 as part of the query wrapper. For example, the installed app(s) 232 may include one or more AppIDs that each indicate one of the installed native applications. As described herein, the search system 100 may store the installed app(s) 232 in the user data store 112 included in the search system 100. Additionally, also in contrast to the example of FIG. 2, the user device 102 of FIG. 6 receives so-called “filtered” search results 230 from the search system 100 in response to transmitting the search query 200 and the installed app(s) 232 to the search system 100. The filtered search results 230 include one or more AAMs 210 that each reference one of the installed native applications and do not reference any native applications that are not installed on the user device 102. Moreover, in the example of FIG. 6, the search system 100 may refrain from transmitting any AppIDs that indicate native applications associated with the filtered search results 230 to the user device 102 as part of the filtered search results 230. As explained herein, in this example, the AAM(s) 210 included in the filtered search results 230 reference one or more of the installed native applications and do not reference any native applications that are not installed on the user device 102.

In the example of FIG. 6, to generate the filtered search results 230, the search system 100 performs a search for one or more function records included in the search data store 110 based on the search query 200 and based on the installed app(s) 232 received from the user device 102. For example, the search system 100 may use the search query 200 and the installed app(s) 232 as search parameters to identify the function records within the search data store 110. In this example, the filtered search results 230 include the AAM(s) 210 selected from the function records identified during the search. Specifically, as described herein, each of the AAM(s) 210 references a native application that is installed on the user device 102 (e.g., one of the native application(s) 228). As also described in, none of the AAM(s) 210 references a native application that is not installed on the user device 102.

FIG. 6 illustrates the manner in which the filtered search results 230 may be displayed to the user on the user device 102. As shown in FIG. 6, the user device 102 displays the filtered search results 230 to the user as user selectable links, or links, 218-1, 218-2, 220-1, 220-2, 220-3, 220-4, 220-5, and 220-6. The links 218-1, 218-2, and 220-1 . . . 220-6 of FIG. 6 are analogous to the links 218-1, 218-2, and 220-1 . . . 220-6 described above with reference to FIG. 2. Each of the links 220-1, 220-2, 220-3, 220-4, 220-5, and 220-6 of FIG. 6 includes one of the AAM(s) 210 received from the search system 100 in response to the search query 200 and the installed app(s) 232. As described herein, each of the AAM(s) 210 specifies an application state within one of the installed native applications and none of the AAM(s) 210 specifies an application state within a native application that is not installed on the user device 102. As such, in the example of FIG. 6, each of the links 220-1 . . . 220-6 is associated with an application state of one of the installed native applications. As a result, the user may access any of the filtered search results 230 displayed on the user device 102 (i.e., the links 220-1, 220-2, 220-3, 220-4, 220-5, and 220-6) without first installing a native application that is not installed, or is unavailable, on the user device 102.

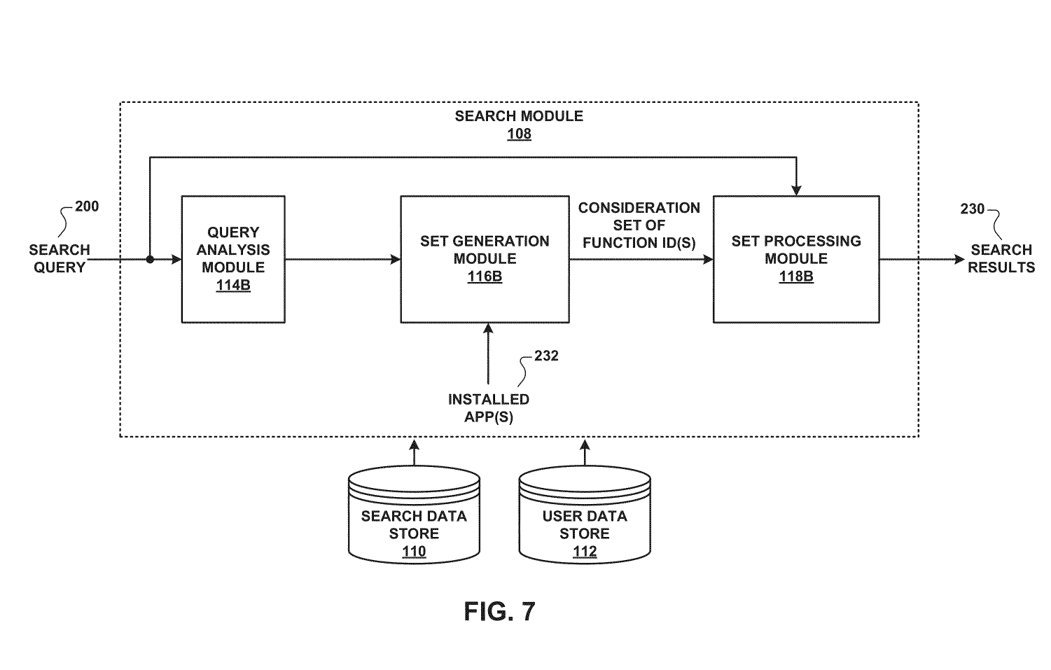

FIG. 7 illustrates another functional block diagram of an example search module 108 that may be included in the search system 100 according to the present disclosure. FIG. 7 also illustrates an example search data store 110 and an example user data store 112 that may be included in the search system 100 according to this disclosure. The search module 108 of FIG. 7 is similar, although not identical, to the search module 108 depicted in FIG. 3. In particular, the search module 108 of FIG. 7 includes a query analysis module 114B, a set generation module 116B, and a set processing module 118B, which serve similar, although not identical, functions to those of the query analysis module 114A, the set generation module 116A, and the set processing module 118A described above with reference to FIG. 3. Specifically, in contrast to the search module 108 of FIG. 3, the search module 108 of FIG. 7 (i.e., the set generation module 116B) receives an indication of each of one or more native applications that are installed on the user device 102 (i.e., the installed app(s) 232). As described herein, the set generation module 116B may receive the installed app(s) 232 from the user device 102 and/or the user data store 112. For example, the set generation module 116B may receive the installed app(s) 232 directly from the user device 102, or from the user data store 112 after the installed app(s) 232 are received from the user device 102 and stored in the user data store 112.

In the example of FIG. 7, the query analysis module 114B receives a query wrapper that includes a search query 200 from the user device 102 and analyzes the received search query 200, as described above. The set generation module 116B receives the installed app(s) 232 from the user device 102 and/or the user data store 112, as also previous described. The set generation module 116B identifies a consideration set of one or more function records included in the search data store 110 based on the received (e.g., analyzed) search query 200 and based on the installed app(s) 232. The set processing module 118B processes (e.g., scores) the consideration set to generate search results 230 that include one or more AAMs selected from the identified function records of the consideration set, and transmits the search results 230 including the AAMs to the user device 102 that generated the search query 200, as also described above.

As previously explained, to identify the consideration set based on the search query 200, the set generation module 116B may identify the function records of the consideration set based on matches between terms of the search query 200 and terms included in the function records. For example, the set generation module 116B may identify the function records based on matches between tokens generated by the query analysis module 114B using the search query 200 and words included in the ASI and/or function IDs of the function records. To identify the consideration set based on the installed app(s) 232, the set generation module 116B may determine that an AAM included in each identified function record of the consideration set references one of the one or more native applications that are installed on the user device 102, as specified by the installed app(s) 232. In a specific example where the installed app(s) 232 include one or more AppIDs that each indicate a native application that is installed on the user device 102, to identify the consideration set based on the installed app(s) 232, the set generation module 116B may determine that an AppID included in each function record of the consideration set corresponds to (e.g., is the same as) one of the one or more AppIDs included in the installed app(s) 232.

As also previously explained, the set processing module 118B processes the consideration set to generate the search results 230 that include the one or more AAMs selected from the function records of the consideration set. In some examples, to process the consideration set, the set processing module 118B generates one or more result scores for the functions records of the consideration set. Accordingly, in some examples, each function record of the consideration set may have a corresponding result score. The set processing module 118B may select one or more function records from the consideration set based on the result scores associated with the function records. For example, the set processing module 118B may select one or more function records of the consideration set that have the highest one or more result scores. The set processing module 118B then selects one or more AAMs from the selected function records and transmits the selected AAMs to the user device 102 that generated the search query 200 as the search results 230. The set processing module 118B may also transmit the result scores associated with the selected AAMs to the user device 102, as described herein.

FIGS. 8A-8B illustrate other example function records 800A and 800B, respectively, that may be included in the search data store 110 of the present disclosure. Specifically, the function record 800A of FIG. 8A is similar to the function record 400A of FIG. 4A. Similarly, the function record 800B of FIG. 8B is similar to the function record 400B of FIG. 4B. As such, the description provided above with reference to the function records 400A and 400B is equally applicable to the function records 800A and 800B. As shown in FIG. 8A, the function record 800A includes a function ID 802A, ASI 804A, one or more AAMs 806A, and an AppID 808A. As shown in FIG. 8B, the function record 800B includes a function ID 802B, ASI 804B, one or more AAMs 806B, and an AppID 808B. The function ID 802A, ASI 804A, and AAM(s) 806A are analogous to the function ID 402A, ASI 404A, and AAM(s) 406A of the function record 400A described above with reference to FIG. 4A. Similarly, the function ID 802B, ASI 804B, and AAM(s) 806B are analogous to the function ID 402B, ASI 404B, and AAM(s) 406B of the function record 400B described above with reference to FIG. 4B.

As shown in FIGS. 8A-8B, the function records 800A and 800B also include the AppID 808A and the AppID 808B, respectively. The AppID 808A of the function record 800A serves as an identifier of the native application referenced by the AAM(s) 806A included in the function record 800A. Similarly, the AppID 808B of the function record 800B serves as an identifier of the native application referenced by the AAM(s) 806B included in the function record 800B. The search system 100 may use the AppID 808A and/or the AppID 808B to generate search results 230 in response to receiving a search query 200 from a user device 102, as described in greater detail below.

In some implementations, the search system 100 may receive a search query 200 from a user device 102, determine one or more native applications that are installed on the user device 102 (e.g., by receiving the installed app(s) 232), and generate search results 230 based on the received search query 200 and based on the determined installed native applications. For example, using the search query 200 and the installed native applications, the search system 100 may identify one or more AAMs that each specify an application state of one of the installed native applications. In these examples, the search system 100 may identify one or more function records stored in the search data store 110 that include the AAMs based on the search query 200 and based on the installed native applications, and select the AAMs from the identified function records. In some examples, a native application referenced by each of one or more of the AAM(s) 806A, 806B may be installed on the user device 102. As such, in these examples, the one or more function records identified by the search system 100 based on the search query 200 and based on the installed native applications may include one or more of the function records 800A, 800B. In other words, in these examples, the AAMs selected by the search system 100 from the identified function records may include one or more of the AAM(s) 806A, 806B.

To identify the function records based on the installed native applications, the search system 100 may determine that an AAM (e.g., any of the AAM(s) 806A and 806B) included in each function record references one of the installed native applications. In some examples, to determine the installed native applications, the search system 100 may determine one or more AppIDs that each identify one of the installed native applications. In these examples, to determine that the AAM included in each of the identified function records references one of the installed native applications, the search system 100 may determine that the function record includes one of the AppIDs (e.g., the same AppID). In these examples, each of the identified function records may include an AppID (e.g., the AppID 808A, or 808B) that identifies a native application referenced by an AAM included in the function record. The search system 100 may transmit the selected AAMs to the user device 102 as the search results 230. The user device 102 may receive the AAMs from the search system 100, generate one or more user selectable links for the AAMs, and display the links on the user device 102.

The AppIDs 808A, 808B may also be used in the context of the techniques described with respect to FIGS. 2-5B. For instance, in other implementations, the search system 100 may receive the search query 200 from the user device 102 and generate the search results 230 based on the received search query 200. For example, using the search query 200, the search system 100 may identify one or more AAMs that each specify an application state of a native application (e.g., an installed native application, or another native application). In these examples, the search system 100 may identify one or more function records, including one or more of the function records 800A, 800B, that include the AAMs based on the search query 200, and select the AAMs from the identified function records. In other words, in these examples, the AAMs may include one or more of the AAM(s) 806A, 806B.

The search system 100 may transmit the AAMs to the user device 102 as the search results 230. In some examples, the search system 100 may transmit each AAM along with an AppID that identifies a native application referenced by the AAM. For example, the AppID (e.g., the AppID 808A, or 808B) may be included within the identified function record (e.g., the function record 800A, or the function record 800B) from which the AAM was selected. In other words, in these examples, the search system 100 may transmit one or more of the AppIDs 808A, 808B to the user device 102 as part of the search results 230. The user device 102 may receive the AAMs and the one or more AppIDs from the search system 100. The user device 102 may further determine the installed native applications. The user device 102 may then generate and display one or more user selectable links for those of the AAMs received from the search system 100 that reference any of the installed native applications. Specifically, the user device 102 may determine whether any of the AAMs reference any of the installed native applications. For each AAM that references an installed native application, the user device 102 may generate a user selectable link that includes the AAM and display the user selectable link on the user device 102. For each AAM that does not reference an installed native application, the user device 102 may refrain from generating a user selectable link that includes the AAM.

In some examples, to determine whether any of the AAMs reference any of the installed native applications, the user device 102 may compare the AppID for each AAM to each of one or more of the installed native applications. The user device 102 may then determine whether any of the AAMs reference any of the installed native applications based on the comparison. In a specific example, to determine the installed native applications, the user device 102 may determine one or more AppIDs that each identify one of the installed native applications. In this example, to compare the AppID for each AAM to each of the one or more of the installed native applications, the user device 102 may compare the AppID for each AAM to each of one or more of the AppIDs that identify the installed native applications.

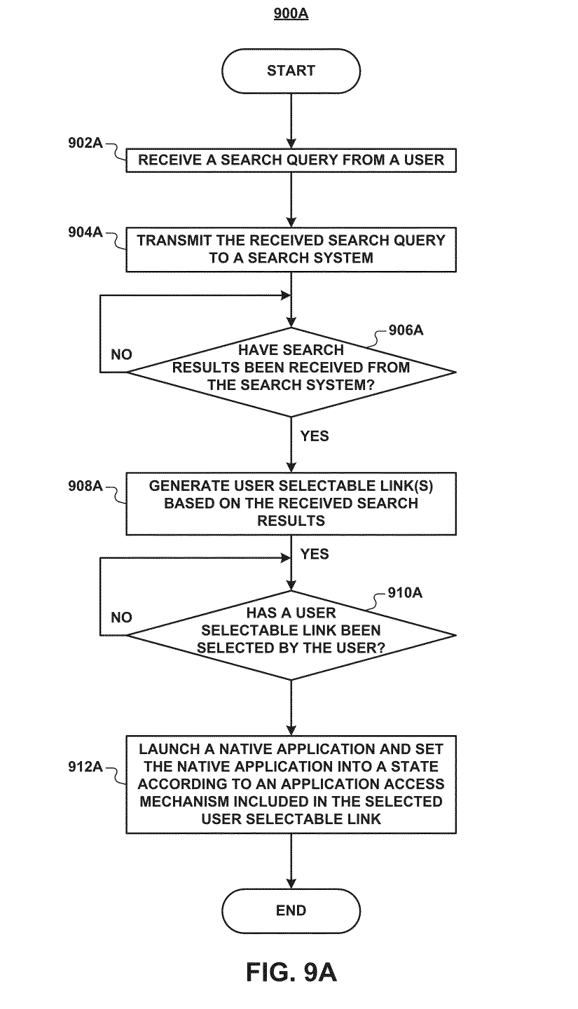

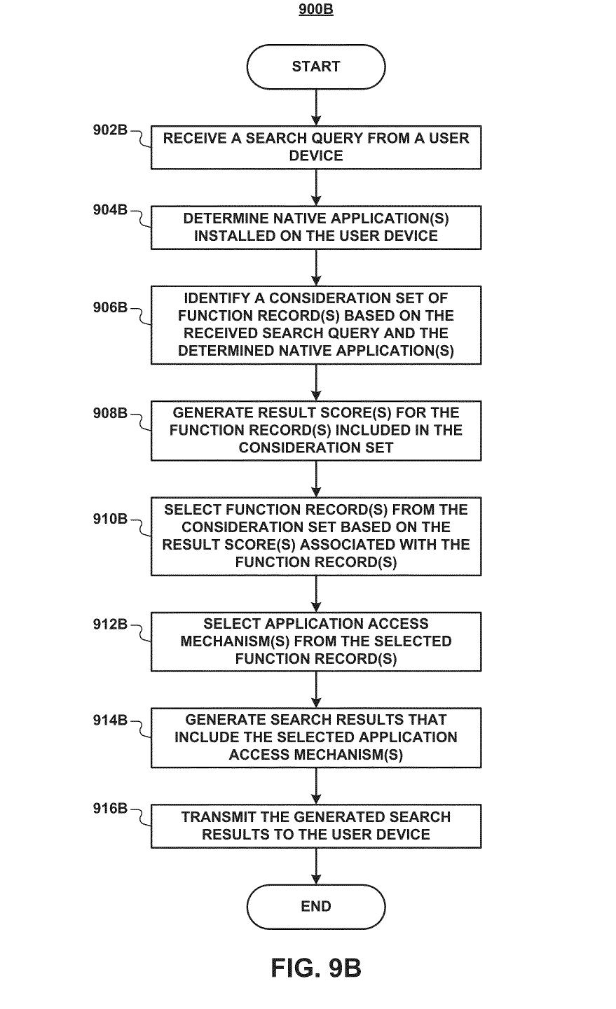

FIG. 9A is a flow diagram that illustrates an example method 900A for transmitting search queries 200 to the search system 100 using a user device 102, receiving search results 230 from the search system 100 at the user device 102 in response to transmitting the search queries 200, and displaying the search results 230 on the user device 102. The user device 102 described with reference to the method 900A includes a search application 226 (e.g., a native application, or a web-based application) that is configured to communicate with users of the user device 102 and with the search system 100. Specifically, the search application 226 is configured to generate a GUI that receives search queries 200 from the users, transmits the search queries 200 to the search system 100, receives search results 230 from the search system 100 in response to the transmitted search queries 200, and displays the received search results 230 to the users. The method 900A of FIG. 9A is described with reference to the search system 100 and the user device(s) 102 of FIGS. 1 and 6, as well as the various components thereof.

In block 902A, the search application 226 receives a search query 200 from a user of the user device 102. For example, the user may have entered the search query 200 into the GUI (e.g., into a search field 202 of the GUI) of the search application 226. In block 904A, the user device 102 transmits the received search query 200 to the search system 100. In block 906A, the user device 102 waits to receive search results 230 from the search system 100 in response to transmitting the search query 200. The method 900A continues in block 908A when the user device 102 receives the search results 230 from the search system 100. As described below with reference to the example method 900B of FIG. 9B, the search results 230 may include one or more AAMs that each reference a native application that is installed on the user device 102. The search results 230 may also include a result score associated with each AAM, as described herein. The search results 230 may further include link data (e.g., text and/or images) for each AAM, as also described herein. The search application 226 may generate a user selectable link for each AAM based on the received link data for the AAM and display the user selectable link in the GUI of the search application 226. The search application 226 may also arrange the user selectable links generated for the AAMs within the GUI based on the received result scores associated with the AAMs (e.g., according to a numerical order of the received result scores).

Accordingly, in block 908A, the search application 226 generates one or more user selectable links based on the received search results 230, in the manner described above. Stated another way, in block 908A, the search application 226 arranges the received search results 230 for display to the user as one or more user selectable links. As explained herein, the displayed search results 230 may include a user selectable link for each AAM included in the search results 230. In block 910A, the search application 226 waits for the user to select one of the user selectable links. The method 900A continues in block 912A when the user selects (e.g., touches, or clicks on) one of the user selectable links displayed to the user. In block 912A, in response to the user selecting one of the user selectable links, the user device 102 launches a native application and sets the native application into an application state according to an AAM included in the selected user selectable link. In other words, in block 912A, the user device 102 launches a native application referenced by an AAM associated with the selected user selectable link and performs one or more operations indicated by the AAM, as described herein.

FIG. 9B is a flow diagram that illustrates an example method 900B for generating search results 230 based on a received search query 200 and based on one or more native applications that are installed on a user device 102. The method 900B is described with reference to the search module 108 of FIGS. 1, 6, and 7, as well as the various components thereof. In block 902B, the query analysis module 114B receives a search query 200 from a user device 102. The query analysis module 114B may analyze the received search query 200, as described herein. For example, the query analysis module 114B may perform one or more of tokenization, filtering, stemming, synonymization, and stop word removal with respect to the search query 200.

In block 904B, the set generation module 116B determines one or more native applications that are installed on the user device 102 (e.g., receives the installed app(s) 232). As described herein, in some examples, to determine the native applications, the set generation module 116B may determine one or more AppIDs that each identify one of the native applications. In some examples, the set generation module 116B may receive an indication of each of the native applications (e.g., one or more AppIDs) from the user device 102, as described herein. For example, the set generation module 116B may receive the one or more indications from the user device 102 along with the search query 200 (e.g., as part of a query wrapper). Additionally, or alternatively, the set generation module 116B may transmit a request for the indications to the user device 102, and receive the indications from the user device 102 in response to transmitting the request. In other examples, the set generation module 116B may retrieve the indications (e.g., the AppID(s)) from the user data store 112, as also described herein. In these examples, prior to the set generation module 116B retrieving the indications from the user data store 112, the user device 102 may provide the indications to the set generation module 116B (e.g., in response to a request transmitted by the set generation module 116B). The set generation module 116B may then store the indications in the user data store 112. Also in these examples, after the set generation module 116B stores the indications in the user data store 112, the user device 102 may provide update information for some or all of the indications to the set generation module 116B (e.g., in response to a request transmitted by the set generation module 116B). The set generation module 116B may then update some or all of the indications using the received update information, and store the updated indication(s) in the user data store 112. The set generation module 116B may then retrieve the updated indication(s) from the user data store 112 in a similar manner as described above.

In block 906B, the set generation module 116B identifies a consideration set of one or more function records included in the search data store 110 based on the received search query 200 (e.g., based on an output of the query analysis module 114B) and based on the determined one or more installed native applications. To identify the function records of the consideration set based on the installed native applications, the set generation module 116B determines that an AAM included in each identified function record references one of the installed native applications. As described herein, in some examples, the set generation module 116B may determine the AppID(s) that each identify one of the installed native applications. In these examples, to determine that the AAM included in each identified function record references one of the installed native applications, the set generation module 116B may determine that the identified function record includes one of the AppID(s). To identify the function records based on the search query 200, the set generation module 116B may identify the function records based on one or more matches between one or more terms of the search query 200 and one or more terms of ASI included in the identified function records. In other words, in block 906B, the set generation module 116B identifies the function records of the consideration set based on both the search query 200 and the installed native applications.

As one example, the set generation module 116B may identify the function records based on the search query 200 and based on the installed native applications by first identifying a plurality of function records included in the search data store 110 based on the search query 200. For example, the set generation module 116B may identify the plurality of function records based on one or more matches between one or more terms of the search query 200 and one or more terms of ASI included in the plurality of function records. In this example, the plurality of function records includes the identified function records. The set generation module 116B may then select the identified function records from the plurality of function records based on the installed native applications. For example, the set generation module 116B may select each of the identified function records from the plurality of function records upon determining that an AAM included in the function record references one of the installed native applications (e.g., upon determining that the function record includes one of the AppID(s)).

As another example, the set generation module 116B may identify the function records based on the search query 200 and based on the installed native applications by performing a search of the search data store 110 using both the search query 200 and the installed native applications as search parameters. In this example, the search data store 110 includes a plurality of function records including the identified function records. Also in this example, the search query 200 is configured to initially restrict a search space of the search. For example, the search query 200 may be configured to restrict the space of the search to include only a subset of the plurality of function records. The subset may include only those function records of the plurality of function records whose function IDs and/or ASI include one or more terms of the search query 200. Also in this example, the installed native applications are configured to further restrict the search space of the search. For example, the installed native applications may be configured to further restrict the space of the search to include only a portion of the subset of the plurality of function records. The portion may include only those function records of the subset whose AAMs reference one of the installed native applications (e.g., that include one of the AppID(s)). Alternatively, in other examples, the installed native applications may be configured to initially restrict the space of the search to include the subset of the plurality of function records, and the search query 200 may be configured to further restrict the space of the search to include only the portion of the subset of the plurality of function records, in a similar manner as described above. As a specific example, to identify the function records based on the search query 200 and based on the installed native applications, the set generation module 116B may perform a search using Lucene® information retrieval software developed by the Apache Software Foundation. In this example, the set generation module 116B may use the search query 200 and an indicator of each of the installed native applications (e.g., an AppID) as search parameters of the search, e.g., as inputs to the Lucene® information retrieval software.

In blocks 908B-910B, the set processing module 118B processes the consideration set, as described herein. Specifically, in block 908B, the set processing module 118B generates result scores for the function records included in the consideration set. In other words, in block 908B, the set processing module 118B generates a result score for each of the function records included in the consideration set. In block 910B, the set processing module 118B selects one or more function records from the consideration set based on the result scores associated with the selected function records. For example, the set processing module 118B may select one or more function records included in the consideration set that have the highest one or more result scores.

In block 912B, the set processing module 118B selects one or more AAMs from the selected function records. In block 914B, the set processing module 118B generates search results 230 that include the selected AAMs. In block 916B, the set processing module 118B transmits the generated search results 230 to the user device 102 that generated the search query 200.

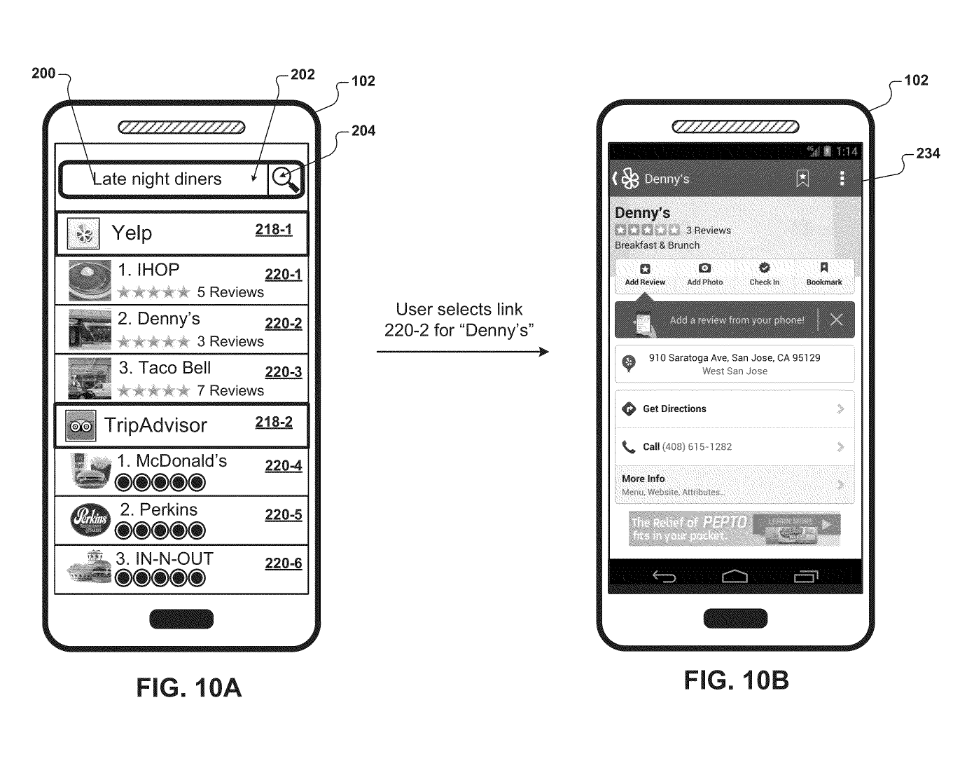

FIGS. 10A-10B illustrate example GUIs that may be generated on the user device 102 according to the present disclosure. In particular, FIGS. 10A-10B illustrate example GUIs of the search application 226 executing on the user device 102, as described herein with reference to FIGS. 2 and 6. In FIG. 10A, a user of the user device 102 has entered a search query 200 into a GUI of the search application 226. Specifically, the user has entered a search query “Late night diners” 200 into a search field (e.g., a so-called “search box,” or “search bar”) 202 of the GUI. The user may have further selected (e.g., touched, or clicked on) a search button 204 of the GUI to cause the search application 226 (i.e., the user device 102) to transmit a query wrapper that includes the search query 200 to the search system 100. In other examples, the user may have caused the search application 226 to transmit the query wrapper to the search system 100 using other techniques (e.g., by touching, or clicking on another button or GUI element, or via voice command). In some examples, the search application 226 may have determined one or more native applications that are installed on the user device 102, as described herein. In other examples, the search application 226 (i.e., the user device 102) may have transmitted indications of some or all of the native applications to the search system 100, as also described herein. For example, the search application 226 may have transmitted the one or more indications to the search system 100 as part of the query wrapper, or separately from the search query 200 (e.g., prior to transmitting the search query 200 to the search system 100).

In the example of FIGS. 10A-10B, the search system 100 has received the query wrapper that includes the search query 200 and has identified one or more function records included in the search data store 110 based on the search query 200. In some examples, the search system 100 may have also received the indications of the installed native applications described above. In these examples, the search system 100 may have identified the function records based on the search query 200 and based on the indications (i.e., based on the installed native applications), as described herein. In any case, the search system 100 has further processed (e.g., scored) the identified function records and has selected one or more AAMs from the processed function records. The search system 100 has then transmitted the selected AAMs to the user device 102 as part of search results 230, e.g., along with link data for generating user selectable links for the AAMs and/or results scores associated with the AAMs for arranging the user selectable links.

In the example of FIG. 10A, the search system 100 has identified function records that represent application states within Yelp and the native application “TRIPADVISOR®” by TripAdvisor, LLC (hereinafter, “TripAdvisor”). In particular, the search system 100 has identified function records that correspond to entries in Yelp for “IHOP.” “Denny's,” and “Taco Bell.” The search system 100 has also identified function records that correspond to entries in TripAdvisor for “McDonald's,” “Perkins,” and “In-N-Out.” In the example of FIGS. 10A-10B, Yelp and TripAdvisor are installed on the user device 102.

Although only user selectable links for the above-described entries in Yelp and TripAdvisor are shown in the GUI of FIG. 10A, in some examples, the search system 100 may have identified one or more additional function records for Yelp, TripAdvisor, and/or other native applications based on the search query 200. In some examples, the search system 100 may have identified the additional function records based on the search query 200 and based on the installed native applications (e.g., based on one or more indications of the installed native applications received from the user device 102). In the examples described above, the search system 100 may have selected one or more additional AAMs from the additional function records and transmitted the additional AAMs to the user device 102 along with the search results 230 in the manner described above.

In some examples, the search system 100 may have identified one or more additional function records that each represent an application state within Yelp, TripAdivsor, or another native application that is installed on the user device 102. For example, the search system 100 may have identified the additional function records based on the search query 200 and based on the installed native applications. In these examples, the search system 100 may have selected one or more AAMs from the additional function records and transmitted the selected AAMs to the user device 102 in the manner described herein. While the GUI of FIG. 10A does not include user selectable links for these additional AAMs, the search application 226 may nevertheless display these user selectable links to the user of the user device 102, e.g., below the links 218-1, 218-2, and 220-1 . . . 220-6 shown in FIG. 10A. For example, the user may view these additional user selectable links by scrolling or paging downward in the GUI.

In other examples, the search system 100 may have identified one or more additional function records that each represent an application state within a native application that is not installed on the user device 102. For example, the search system 100 may have identified the additional function records based on the search query 200. In these examples, the search system 100 may have selected one or more AAMs from the additional function records and transmitted the selected AAMs to the user device 102 in the manner described herein. The GUI of FIG. 10A does not include user selectable links for these additional AAMs because, in these examples, the search application 226 may be configured to refrain from generating these user selectable links and displaying them to the user. For example, the search application 226 may have determined the installed native applications, as described above. The user device 102 may have received the additional AAMs from the search system 100, as also described above. Upon determining that the additional AAMs do not reference any of the installed native applications, the search application 226 may have refrained from generating user selectable links for the AAMs and displaying them to the user.

In still other examples, the search system 100 may not identify any function records that represent application states within native applications that are not installed on the user device 102. The GUI of FIG. 10A does not include user selectable links for AAMs included in these function records because, in these examples, the search system 100 did not identify these function records. For example, the search system 100 may have received the search query 200 and the one or more indications of the installed native applications, as described above. The search system 100 may have further identified one or more function records based on the search query 200 and based on the indications (i.e., based on the installed native applications), as also described above. In these examples, the identified function records do not include any function records that represent application states within (i.e., that include AAMs that reference) native applications that are not installed on the user device 102.

As explained herein, the search results 230 transmitted from the search system 100 to the user device 102 in response to the search query 200 include AAMs for the application functions/states indicated in the links 220-1, 220-2, . . . , 220-6 (collectively, the “links 220”). The search results 230 also include link data (e.g., text and/or images) associated with each of the AAMs. For example, the “IHOP” link 220-1 includes the text “IHOP” and an image of pancakes. The user of the user device 102 may select (e.g., touch, or click on) the links 220 to access the application functions/states indicated in the links 220. For example, the user may select an area of the GUI of FIG. 10A including the “IHOP” link 220-1 to access the entry in Yelp for “IHOP.” In FIG. 10A, the links 220 are grouped together according to the native applications associated with the links 220. For example, the Yelp links 220-1, 220-2, and 220-3 and the TripAdvisor links 220-4, 220-5, and 220-6 are grouped together under Yelp and TripAdvisor headers 218-1, 218-2, respectively. In other examples, user selectable links for different native applications may be mixed instead of grouped.

In the example of FIG. 10A, the user has selected the “Denny's” link 220-2. In response to selection of the “Denny's” link 220-2, the user device 102 has launched Yelp and has performed one or more operations according to the AAM associated with the “Denny's” link 220-2. As a result of performing the operations, the user device 102 has set Yelp into an application state specified by the AAM. In the example of FIG. 10A, the AAM associated with the “Denny's” link 220-2 may reference Yelp and indicate a path for Yelp to find information for the “DENNY'S®” restaurant referenced in the link. For example, an ARI included in the AAM may reference Yelp and indicate one or more operations for Yelp to perform, such as retrieving data from a path included in the ARI. Accordingly, the ARI of the AAM may cause Yelp to perform the function of retrieving and displaying information for the “DENNY'S®” restaurant. An example of the ARI may include the string “yelp:///biz/dennys-sunnyvale.” FIG. 10B shows an example GUI 234 of Yelp after the user has selected the “Denny's” link 220-2. In FIG. 10B, Yelp is set into an application state in which Yelp is displaying retrieved information about the “DENNY'S®” restaurant referenced in the “Denny's” link 220-2 shown in FIG. 10A.

The modules and data stores included in the search systems 100 represent features or functionality that may be included in the search system 100 as it is described in the present disclosure. For example, the search module 108, the search data store 110, the user data store 112, and the components thereof may represent features included in the search system 100. The modules and data stores described herein may be embodied by electronic hardware, software, firmware, or any combination thereof. Depiction of different features or functionality as separate modules or data stores does not necessarily imply whether the modules or data stores are embodied by common or separate electronic hardware, software, or firmware components. In some implementations, the features or functionality associated with one or more of the modules and data stores depicted herein may be realized by common or separate electronic hardware, software, or firmware components.

The modules and data stores may be embodied by electronic hardware, software, and/or firmware components including, but not limited to, one or more processing units, one or more memory components, one or more input/output (I/O) components, and one or more interconnect components. The interconnect component(s) may be configured to provide communication between the processing unit(s), the memory component(s), and the I/O component(s). For example, the interconnect component(s) may include one or more buses that are configured to transfer data between electronic components. The interconnect component(s) may also include one or more control circuits (e.g., a memory controller and/or an I/O controller) that are configured to control communication between electronic components.

The processing unit(s) may include one or more central processing units (CPUs), graphics processing units (GPUs), digital signal processing units (DSPs), application specific integrated circuits (ASICs), field programmable gate arrays (FPGAs), or other processing units. The processing unit(s) may be configured to communicate with the memory component(s) and the I/O component(s). For example, the processing unit(s) may be configured to communicate with the memory component(s) and the I/O component(s) via the interconnect component(s).

A memory component as described herein may include any volatile or non-volatile media. For example, a memory component may include, but is not limited to, electrical media, magnetic media, and/or optical media, such as random access memory (RAM), non-volatile RAM (NVRAM), read-only memory (ROM), electrically-erasable programmable ROM (EEPROM), Flash memory, solid state drives (SSDs), hard disk drives (HDDs), magnetic tape drives, optical storage technology (e.g., compact disc, digital versatile disc, and/or Blu-ray Disc), or any other equivalent or similar memory components.

As such, the one or more memory component(s) may include (e.g., store) various types of data. For example, the memory component(s) may store data included in one or more of the function records(s) of the search data store 110. The memory component(s) may also store one or more indications of native applications that are installed on a user device 102, which are included in the user data store 112 as described herein. The memory component(s) may also include one or more instructions that may be executed by the processing unit(s). For example, the memory component(s) may include one or more computer-readable instructions that, when executed by the processing unit(s), cause the processing unit(s) to perform the various functions attributed to the modules and data stores described herein.

The I/O component(s) may refer to electronic hardware, software, and/or firmware that provide communication with a variety of different devices. For example, the I/O component(s) may provide communication between other devices and the processing unit(s) and the memory component(s). In some examples, the I/O component(s) may be configured to communicate with a computer network, such as the network 106. For example, the I/O component(s) may be configured to exchange data over a computer network using any of a variety of different physical connections, wireless connections, and protocols. The I/O component(s) may include, but are not limited to, one or more network interface components (e.g., a network interface controller), repeaters, network bridges, network switches, routers, and firewalls. In some examples, the I/O component(s) may include hardware, software, and/or firmware that is configured to communicate with various human interface devices, including, but not limited to, display screens, keyboards, pointer devices (e.g., a mouse), touchscreens, speakers, and microphones. In other examples, the I/O component(s) may provide communication with additional devices, such as external memory (e.g., external HDDs).

In some implementations, the search system 100 may be a system of one or more computing devices (e.g., a computer-based search system) that are configured to implement the techniques described herein. In other words, the features or functionality attributed to the modules and data stores described herein may be implemented by one or more computing devices. Each of the computing device(s) may include any combination of electronic hardware, software, and/or firmware, as described above. Additionally, each computing device may include any combination of processing units, memory components, I/O components, and interconnect components, as also described above. The computing device(s) of the search system 100 may also include various human interface devices, including, but not limited to, display screens, keyboards, pointing devices (e.g., a mouse), touchscreens, speakers, and microphones. The computing device(s) may also be configured to communicate with additional devices, such as external memory (e.g., external HDDs).

The computing device(s) of the search system 100 may be configured to communicate with the network 106. The computing device(s) may also be configured to communicate with one another (e.g., within the search system 100) via a computer network. In some examples, the computing device(s) may include one or more server computing devices configured to communicate with user devices, such as the user device(s) 102 (e.g., receive search queries 200 and transmit search results 230). The server computing device(s) may also gather data from the data source(s) 104, index the data, and store the data, as well as gather, index, and/or store other documents or information. The computing device(s) of the search system 100 may reside within a single machine or within multiple machines at a single geographic location, or may be distributed across a number of geographic locations.

Additionally, the various implementations of the search system 100 described above (e.g., using one or more computing devices that include one or more processing units, memory components, I/O components, and interconnect components) are equally applicable to any of the user device(s) 102, as well as to the various components thereof, as described herein.

What is claimed is:

1. A method comprising:
receiving a search query from a user device;
determining one or more native applications that are installed on the user device;
identifying function records based on the search query and based on the one or more native applications, each function record including an application access mechanism and application state information, wherein the application access mechanism references a native application and indicates one or more operations for the native application to perform, wherein the application state information describes a state of the native application after the native application has performed the one or more operations, and wherein identifying the function records based on the one or more native applications comprises determining that the application access mechanism included in each function record references one of the one or more native applications;
selecting one or more application access mechanisms from the identified function records; and
transmitting the selected one or more application access mechanisms to the user device.

2. The method of claim 1, wherein identifying the function records based on the search query comprises identifying the function records based on matches between terms of the search query and terms of the application state information included in the identified function records.

3. The method of claim 1, wherein determining the one or more native applications that are installed on the user device comprises receiving an indication of each of the one or more native applications from the user device, and determining the one or more native applications based on the received one or more indications.

4. The method of claim 3, wherein receiving the indication of each of the one or more native applications from the user device comprises receiving the one or more indications along with the search query as part of a query wrapper.

5. The method of claim 3, wherein receiving the indication of each of the one or more native applications from the user device comprises transmitting a request for the one or more indications to the user device, and receiving the one or more indications from the user device in response to the transmitted request.

6. The method of claim 1, wherein determining the one or more native applications that are installed on the user device comprises retrieving an indication of each of the one or more native applications from a data store, and determining the one or more native applications based on the retrieved one or more indications.

7. The method of claim 6, further comprising, prior to retrieving the indication of each of the one or more native applications from the data store, receiving the one or more indications from the user device, and storing the one or more indications in the data store.

8. The method of claim 7, wherein receiving the one or more indications from the user device comprises transmitting a request for the one or more indications to the user device, and receiving the one or more indications from the user device in response to the transmitted request.

9. The method of claim 7, further comprising, prior to retrieving the indication of each of the one or more native applications from the data store, receiving update information for at least one of the one or more indications stored in the data store from the user device, and updating the at least one of the one or more indications using the received update information.

10. The method of claim 1, wherein the one or more native applications that are installed on the user device comprise a subset of native applications that are available on the user device, and wherein the subset is specified by a user of the user device based on one or more privacy considerations associated with the native applications that are available on the user device.

11. The method of claim 1, wherein determining the one or more native applications that are installed on the user device comprises determining one or more application identifiers that each identify one of the one or more native applications, and wherein determining that the application access mechanism included in each of the identified function records references one of the one or more native applications comprises determining that the identified function record includes one of the one or more application identifiers.

12. The method of claim 1, wherein identifying the function records based on the search query and based on the one or more native applications comprises identifying a plurality of function records that includes the identified function records based on the search query, and selecting the identified function records from the plurality of function records based on the one or more native applications.

13. The method of claim 1, wherein identifying the function records based on the search query and based on the one or more native applications comprises performing a search of a data store that includes a plurality of function records including the identified function records using the search query and the one or more native applications as search parameters, wherein the search query is configured to restrict a search space of the search, and wherein the one or more native applications are configured to further restrict the search space of the search.

14. The method of claim 1, wherein identifying the function records based on the search query and based on the one or more native applications comprises performing a search of a data store that includes a plurality of function records including the identified function records using the search query and the one or more native applications as search parameters, wherein the one or more native applications are configured to restrict a search space of the search, and wherein the search query is configured to further restrict the search space of the search.

15. The method of claim 1, wherein identifying the function records based on the search query and based on the one or more native applications comprises performing a search using Lucene® information retrieval software developed by the Apache Software Foundation, wherein the search query and an indicator of each of the one or more native applications comprise search parameters of the search.

16. A method comprising:
transmitting, using a user device, a search query to a search system configured to generate search results in response to a received search query;
receiving search results from the search system at the user device in response to the search query, wherein the search results include one or more application access mechanisms that each reference a native application and indicate one or more operations for the native application to perform;
determining, using the user device, one or more native applications that are installed on the user device;
determining, using the user device, whether any of the one or more application access mechanisms reference any of the one or more native applications;
for each of the one or more application access mechanisms that references any of the one or more native applications, generating, using the user device, a user selectable link that includes the application access mechanism and displaying the user selectable link on the user device; and
for each of the one or more application access mechanisms that does not reference any of the one or more native applications, refraining from generating a user selectable link that includes the application access mechanism and displaying the user selectable link on the user device.

17. The method of claim 16, wherein determining the one or more native applications that are installed on the user device comprises polling an operating system of the user device, receiving an indication of each of the one or more native applications from the operating system in response to polling the operating system, and determining the one or more native applications based on the received one or more indications.

18. The method of claim 16, wherein determining the one or more native applications that are installed on the user device comprises retrieving an indication of each of the one or more native applications from a data store, and determining the one or more native applications based on the retrieved one or more indications.

19. The method of claim 18, further comprising, prior to retrieving the indication of each of the one or more native applications from the data store, polling an operating system of the user device, receiving the indication of each of the one or more native applications from the operating system in response to polling the operating system, and storing the one or more indications in the data store.

20. The method of claim 19, further comprising, prior to retrieving the indication of each of the one or more native applications from the data store, polling the operating system, receiving update information for at least one of the one or more indications stored in the data store in response to polling the operating system, and updating the at least one of the one or more indications using the received update information.

21. The method of claim 16, wherein determining the one or more native applications that are installed on the user device comprises receiving an indication of each of the one or more native applications from a user of the user device, and determining the one or more native applications based on the received one or more indications.

22. The method of claim 21, wherein the one or more native applications that are installed on the user device comprise a subset of native applications that are available on the user device, and wherein the subset is specified by the user of the user device based on one or more privacy considerations associated with the native applications that are available on the user device.

23. The method of claim 16, further comprising receiving link data from the search system at the user device for each of the one or more application access mechanisms that references any of the one or more native applications, wherein the link data includes at least one of text and an image that describe a state of a native application specified by the application access mechanism, and wherein generating the user selectable link that includes the application access mechanism comprises generating the user selectable link using the link data.

24. The method of claim 16, wherein the search results further include, for each of the one or more application access mechanisms, an application identifier that identifies the native application referenced by the application access mechanism, and wherein determining whether any of the one or more application access mechanisms references any of the one or more native applications comprises:
comparing the application identifier for each of the one or more application access mechanisms to each of at least one of the one or more native applications; and
determining whether any of the one or more application access mechanisms references any of the one or more native applications based on the comparison.

25. The method of claim 24, wherein determining the one or more native applications that are installed on the user device comprises determining one or more application identifiers that each identify one of the one or more native applications, and wherein comparing the application identifier for each of the one or more application access mechanisms to each of the at least one of the one or more native applications comprises comparing the application identifier for each of the one or more application access mechanisms to each of at least one of the one or more application identifiers that each identify one of the one or more native applications.

26. The method of claim 16, wherein each of the one or more application access mechanisms includes an application resource identifier, and wherein determining whether any of the one or more application access mechanisms references any of the one or more native applications comprises:
comparing at least a portion of the application resource identifier included in each of the one or more application access mechanisms to each of at least one of the one or more native applications; and
determining whether any of the one or more application access mechanisms references any of the one or more native applications based on the comparison.

27. The method of claim 26, wherein the portion of the application resource identifier included in each of the one or more application access mechanisms comprises a domain name that indicates the native application referenced by the application access mechanism.

28. A system comprising one or more computing devices configured to:
receive a search query from a user device;
determine one or more native applications that are installed on the user device;
identify function records based on the search query and based on the one or more native applications, each function record including an application access mechanism and application state information, wherein the application access mechanism references a native application and indicates one or more operations for the native application to perform, wherein the application state information describes a state of the native application after the native application has performed the one or more operations, and wherein to identify the function records based on the one or more native applications, the one or more computing devices are configured to determine that the application access mechanism included in each function record references one of the one or more native applications;
select one or more application access mechanisms from the identified function records; and
transmit the selected one or more application access mechanisms to the user device.

29. A system comprising one or more computing devices configured to:
transmit a search query to a search system configured to generate search results in response to a received search query;
receive search results from the search system in response to the search query, wherein the search results include one or more application access mechanisms that each reference a native application and indicate one or more operations for the native application to perform;
determine one or more native applications that are installed on a user device;
determine whether any of the one or more application access mechanisms references any of the one or more native applications;
for each of the one or more application access mechanisms that references any of the one or more native applications, generate a user selectable link that includes the application access mechanism and display the user selectable link; and
for each of the one or more application access mechanisms that does not reference any of the one or more native applications, refrain from generating a user selectable link that includes the application access mechanism and displaying the user selectable link.

30. A non-transitory computer-readable storage medium comprising instructions that cause one or more computing devices to:
receive a search query from a user device;
determine one or more native applications that are installed on the user device;
identify function records based on the search query and based on the one or more native applications, each function record including an application access mechanism and application state information, wherein the application access mechanism references a native application and indicates one or more operations for the native application to perform, wherein the application state information describes a state of the native application after the native application has performed the one or more operations, and wherein the instructions that cause the one or more computing devices to identify the function records based on the one or more native applications comprise instructions that cause the one or more computing devices to determine that the application access mechanism included in each function record references one of the one or more native applications;
select one or more application access mechanisms from the identified function records; and
transmit the selected one or more application access mechanisms to the user device.

31. A non-transitory computer-readable storage medium comprising instructions that cause one or more computing devices to:
transmit, using a user device, a search query to a search system configured to generate search results in response to a received search query;
receive search results from the search system at the user device in response to the search query, wherein the search results include one or more application access mechanisms that each reference a native application and indicate one or more operations for the native application to perform;
determine, using the user device, one or more native applications that are installed on the user device;
determine, using the user device, whether any of the one or more application access mechanisms references any of the one or more native applications;
for each of the one or more application access mechanisms that references any of the one or more native applications, generate, using the user device, a user selectable link that includes the application access mechanism and display the user selectable link on the user device; and
for each of the one or more application access mechanisms that does not reference any of the one or more native applications, refrain from generating a user selectable link that includes the application access mechanism and displaying the user selectable link on the user device.
